(19) United States
(12) Patent Application Publication
(10) Pub. No.: US 2026/0230122 A1
(43) Pub. Date: Aug. 6, 2026

(54) METHOD OF DETERMINING A PROCESS FOR GENERATING PRECODING AND COMBINING PARAMETERS FOR RATE SPLITTING MULTIPLE ACCESS IN A MU-MIMO COMMUNICATION SYSTEM, AND TRANSMITTER AND RECEIVER IMPLEMENTING THE METHOD

(71) Applicant: Continental Automotive Technologies GmbH, Hannover (DE)

(72) Inventors: David Gonzalez Gonzalez, Hannover (DE); Osvaldo Gonsa, Hannover (DE); Kengo Ando, Bremen (DE); Giuseppe Thadeu Freitas de Abreu, Bremen (DE); Hyeon Seok Rou, Bremen (DE)

(73) Assignee: Continental Automotive Technologies GmbH, Hannover (DE)

(21) Appl. No.: 19/153,287

(22) PCT Filed: Jan. 29, 2024
(86) PCT No.: PCT/EP2024/052018

§ 371 Date: Aug. 1, 2025

(30) Foreign Application Priority Data
Feb. 3, 2023 (DE) 10 2023 200 905.6

(51) Int. Cl. H04B 7/0452; H04B 7/0456; H04B 7/06; H04L 25/02

(52) U.S. Cl. CPC H04B 7/0452; H04B 7/0456; H04B 7/0632; H04L 25/0204; H04L 25/0224; H04L 25/0242

(57) ABSTRACT

A method of determining a process for generating precoding and combining parameters in a MU-MIMO RSMA communication system is presented. The determining process uses a selectable targeted property of the communication connections, a selectable process for processing respective errors associated with estimated channel coefficient matrices of all communication channels, and a selectable design technique as inputs. Further, a method of generating precoding and combining parameters for wireless interfaces of a first and a second communication device, respectively, in accordance with the previously determined process is presented. The generating process provides joint determination of precoding and combining parameters in MU-MIMO RSMA communication systems in which the CSI is only imperfectly known. Yet further, methods for operating first and second wireless communication devices in a MU-MIMO RSMA communication system using the precoding and combining parameters determined in accordance with the process are presented.

### CROSS REFERENCE TO RELATED APPLICATIONS

This application is the U.S. National Phase Application of PCT International Application No. PCT/EP2024/052018, filed Jan. 29, 2024, which claims priority to German Patent Application No. 10 2023 200 905.6, filed Feb. 3, 2023, the contents of such applications being incorporated by reference herein.

### FIELD OF THE INVENTION

The invention relates to the field of wireless communication, in particular to wireless communication using rate splitting multiple access (RSMA) in a multi-user multiple-input multiple-output (MU-MIMO) communication system.

### NOTATIONS

Scalar values are denoted herein by lowercase letters in italics, as in x, while complex vectors and matrices are denoted by boldface lowercase and uppercase letters, as in x and X, respectively. Complex tensors are represented by bold capital letters in calligraphic font, as in H. (⋅)^{T} and (⋅)* denote the transposition and complex conjugation operators respectively, and diag(⋅) denotes the diagonalization operator. |⋅| denotes the absolute value operator whereas the ∥ ∥ [symbol] denotes the z,54 -th norm. [symbol] (x) and Varₓ(x) respectively denote the expectation and variance operator of x with respect to the distribution of x given by [symbol] (x). [symbol] and [symbol] denote the real and complex number fields respectively, and XN(μ, v) denotes the real and complex Gaussian distributions with mean μ and variance v.

### BACKGROUND

The current fifth (5G) and upcoming sixth generation (6G) wireless communications and beyond are designed to serve a large number of high-mobility users, e.g., vehicles, subways, highways, trains, drones, low earth orbit (LEO) satellites, etc. The core requirements for 5G communications include serving data-driven use cases with a data rate requirement of up to 20 Gbps in the downlink (DL), i.e., enhanced mobile broadband (eMBB), providing ultra-reliable low latency communications (URLLC) with block error rates (BLER) of 10⁻⁵ or less and latencies of 1 ms or lower, and providing grant-free access in the uplink (UL) to a large number of low-complexity and low-power devices, inter alia for enabling massive machine type communications (mMTC). These requirements may not necessarily be met simultaneously. The core requirements for 6G communications go beyond those of 5G, including simultaneously meeting eMBB and URLLC, simultaneously meeting enhanced eMBB and mMTC, enhanced URLLC and mMTC, and simultaneously meeting enhanced eMBB, URLLC and mMTC, although trade-off-based, i.e., accepting compromises in any one or more of the three.

Various methods of ensuring proper access of multiple user equipment (UE) units to a base station (BS) using the shared wireless resource are known. The initially deployed communication systems typically used so-called orthogonal multiple access (OMA) schemes, which may be considered as serving a single user per resource. More recent developments lead to the advent of non-orthogonal multiple access (NOMA) methods, which may be considered as serving multiple users per resource. This simple distinction does not fully reflect modern communication designs, in which OMA-based communication networks actually serve multiple users on orthogonal resources using time division multiple access (TDMA), frequency division multiple access (FDMA), code division multiple access (CDMA), or orthogonal frequency division multiple access (OFDMA). In addition, these modern communication systems often are equipped with multiple antennas and can further extend the multi user access through spatial domain processing in the form of multiuser linear precoding (MU-LP), space division multiple access (SDMA), multiuser multiple-input multiple-output (MU-MIMO), and massive MIMO. MU-LP, SDMA, MU-MIMO serve users in a nonorthogonal manner since multiple users are allocated different precoders, resulting in different “beams” directed to the respective different users, in the same time-frequency grid and interfere with each other in the same cell. All these multi user access schemes require a proper interference management, either on the transmit side or the receive side, for proper interference cancellation (IC).

Already the existing 5G communications are subject to challenges such as multi-user interference due to imperfect channel state information (CSI) at the transmitter (CSIT) when performing MIMO beamforming. Outdated CSIT may be caused, inter alia, by high mobility, where channels change during processing time required for determining the CSI, and channel blockages due to objects appearing in the wireless communication paths while the CSI is processed.

Conventional multi-user multi-antenna approaches such as SDMA, MU-MIMO heavily rely on timely and highly-accurate CSIT or CSI at the receiver (CSIR). In practice, CSIT/R is always imperfect, inter alia due to pilot reuse, channel estimation (CE) errors, pilot contamination, limited and quantised feedback accuracy, delay and latency, mobility—in the form of ever-increasing speeds of vehicles, trains, satellite, flying objects and emerging applications as Vehicle-to-Everything-radio frequency (RF) impairments, e.g., phase noise, inaccurate calibrations of RF chains, sub-band level estimation, and so on.

Rate-Splitting Multiple Access (RSMA) has more recently emerged as a powerful multiple access, interference management, and multi-user strategy for next generation communication systems. RSMA refers to a broad class of multi-user schemes whose commonality is to rely on the rate-splitting (RS) principle. RS consists in splitting the messages into respective common and private parts, distributedly encoding and precoding the common parts into a common stream, and the private parts into private streams, and superposing, in a non-orthogonal manner, the common stream on top of all private streams, i.e., simultaneously transmitting the common and private streams.

In the downlink, RSMA uses linearly or non-linearly precoded RS at the transmitter, i.e., at the base station (300), to split each user message into one or multiple common messages and a private message. The common messages are combined and encoded into common streams for the intended users. The common stream is decodable by all receivers, while the private streams are to be decoded by their corresponding receivers only. A receiver would have to retrieve each part to reconstruct the original message. After decoding the common stream from the received signal the receiver applies successive interference cancellation (SIC)—or any other form of joint decoding—to the common stream, for enabling proper decoding of the private stream. The decoded common and private streams are combined for retrieving the originally transmitted messages.

A key benefit of RS and its message splitting capability is to flexibly manage inter-user interference. In fact, RS can be seen as a combination of transmit-side and receive-side interference cancellation where the contribution of the common stream can be adjusted according to the level of interference that needs to be cancelled by the receiver. This departs from the transmit transmit-side only and receive-side only interference cancellation strategies of SDMA and NOMA, respectively.

Using RSMA in MU-MIMO systems, i.e., systems in which the BSs and UEs have multiple antennas configured for beamforming, also referred to as spatial multiplexing, requires proper precoding in the transmitter for proper beamforming and proper combining in the receiver to make the best use of the signals of all antennas. The spatial multiplexing introduces additional multi-user interference, inter alia due to imperfect beamforming that inevitably “leaks” a part of the signal to other UEs not targeted by the beam, that needs to be dealt with in the receiver. While the common channel part of RSMA may still provide useful information for those UEs that are not targeted by a beam for performing CE and IC, currently no joint precoder and combiner exists that takes into account, on the transmission side, uncertain CSI and the resulting imperfect SIC in receivers of a MU-MIMO RSMA system, leaving MU-MIMO RSMA systems prone to performance degradation. This challenge is particularly difficult to address in heterogeneous systems, where different UEs have different numbers of antennas, and the known methods cannot be used in such situations or have a severely degraded performance.

### SUMMARY OF THE INVENTION

It is, therefore, desirable to provide an improved method of determining precoding and combining parameters for wireless devices of MU-MIMO RSMA communication systems, and to provide corresponding receivers and transmitters, which are adapted to situations in which the transmitter and/or the receiver do not have perfect knowledge of the CSI, as well as methods of operating the receiver and transmitter, respectively. It is further desirable to provide methods and apparatus that can be used in communication systems having UEs with different numbers of antennas without suffering from severe performance degradation.

This need is addressed by methods of determining a process for generating precoding and combining parameters, the method of operating a first wireless communication device, the method of operating a second wireless communication device, a wireless communication device, and a computer program product. A corresponding computer-readable storage medium is also presented. Embodiments and developments of the methods and apparatus, respectively, are also provided.

In particular, the methods described hereinafter consider the problem in the downlink direction of such MU-MIMO RSMA systems, that imperfect CSI at the receiver severely hinders the decoding process, e.g., the SIC process, and, therefore, the detection of transmit symbols in the receiver.

An aspect of the invention will be described in the following assuming an exemplary MU-MIMO RSMA communication system comprising a first wireless communication device, e.g., a base station (300) with Nₜ≥1 transmit antennas, and K second wireless communication devices, e.g., user equipment (400) each with Mₖ≥1 antennas. In such a system, the RSMA transmit signal x∈ [symbol] ^{N}^{ₜ}^{×M}^{ₖ} is given by

$$x = {V}_{c} {s}_{c} + {\sum }_{k ∈ 𝒦} {V}_{k} {s}_{k}$$

where s_{c}~XN(0, I_{Lc}) and V_{c}∈ [symbol] ^{N}^{ₜ}^{×L}^{_{c}} are the common signal and the precoder matrix for the L_{c} length common signal, respectively, and sₖ~XN(0, I_{Lk}) and Vₖ∈ [symbol] ^{N}^{ₜ}^{×L}^{ₖ} are the private signal and the precoder matrix for the Lₖ length private signal, respectively, for the k-th UE. K is a set of indices for all receivers, or UEs.

The received signal at the k-th UE, yₖ, is expressed as

$${y}_{k} = {H}_{k} x + {n}_{k} ∈ {ℂ}^{{M}_{k} \times 1} ,$$

where Hₖ∈ [symbol] ^{M}^{ₖ}^{×N}^{ₜ} is the actual channel matrix between the base station (300) and the k-th UE, nₖ is the received additive white Gaussian noise (AWGN) vector,

At the k-th receiving UE's side, initially the messages of interest are the common signal s_{c} which is directly detected from the s_{c}-component carried in the received signal yₖ, and the k-th private signal sₖ obtained by applying successive interference cancellation (SIC) to the received signal with the knowledge of estimated common signal s_{c}.

The received common signal, y_{c,k}, can be written as

$${y}_{c , k} = {U}_{c , k} {H}_{k} x + {U}_{c , k} {n}_{k} ∈ {ℂ}^{{M}_{k} \times 1} \qquad ( 1 )$$

where U_{c,k} denotes the combiner matrix for the common message at the k-th receiver, or UE, and

$${n}_{k} ∼ XN ( 0 , {σ}_{n}^{2} {I}_{M k} )$$

is the additive white gaussian noise (AWGN) at the k-th receiver, or UE.

In the ideal case assumed above each UE has perfect knowledge of the actual channel coefficient matrix Hₖ, which allows performing perfect SIC at the receiver, yielding a soft replica y̌ₖ∈ [symbol] ^{M}^{ₖ}^{×1} as

$${\check{y}}_{k} = {U}_{k} ( {H}_{k} x + {n}_{k} - {H}_{k} {V}_{c} {s}_{c} ) = {\sum }_{{k}^{′} ∈ 𝒦} {U}_{k} {H}_{k} {V}_{{k}^{′}} {s}_{{k}^{′}} + {U}_{k} {n}_{k}$$

where Uₖ is the combiner matrix for the k-th receiver's, or UE's, private signal.

Based on the system description above the achievable total rate Rₜₒₜₐₗ of the RSMA transmission from the BS to the k-th receiver, or UE, using the corresponding rates R_{c,k} and Rₖ for the k-th receiver's common signal and private signal, respectively, is derived as

$${R}_{total} {=}^{Δ} {min}_{k} ( {R}_{c , k} ) + {\sum }_{k ∈ 𝒦} {R}_{k} \\ {R}_{c , k} = {log}_{2} ( det ( {I}_{M} + {Γ}_{c , k} ) ) \\ {R}_{k} = {log}_{2} ( det ( {I}_{M} + {Γ}_{k} ) )$$

with the SINRs of the common and private messages given by

$${Γ}_{c , k} = {V}_{c}^{H} {H}_{k}^{H} {{U}_{c , k}^{H} ( {\sum }_{{k}^{′} ∈ 𝒦} {U}_{c , k} {H}_{k} {V}_{{k}^{′}} {V}_{{k}^{′}}^{H} , {H}_{k}^{H} {U}_{c , k}^{H} + {σ}_{n}^{2} {I}_{M} )}^{- 1} {U}_{c , k} {H}_{k} {V}_{c}$$

$$and$$

$${Γ}_{k} = {V}_{k}^{H} {H}_{k}^{H} {{U}_{k}^{H} ( {\sum }_{{k}^{′} ∈ 𝒦 \backslash k} {U}_{k} {H}_{k} {V}_{{k}^{′}} {V}_{{k}^{′}}^{H} {H}_{k}^{H} {U}_{k}^{H} + {σ}_{n}^{2} {I}_{M} )}^{- 1} {U}_{k} {H}_{k} {V}_{k}$$

respectively, where U_{c,k} and Uₖ are the combiner matrices for the common signal and the private signal at the receiver, respectively.

In the MU-MIMO case discussed herein the estimated recovered common signal ŝ_{c} is expressed as

$${\hat{s}}_{c} = R e c ( {y}_{k} \vert {H}_{k} , {V}_{c} , {U}_{c , k} )$$

Where yₖ is the received signal, V_{c} is the beamformer matrix at the transmitter, U_{c,k} is the beamformer matrix at the receiver, and Hₖ is the channel coefficient matrix, which is assumed ideal in this case.

The estimated recovered private signal ŝₖ is expressed as

$${\hat{s}}_{k} = R e c ( {y}_{k} - {H}_{k} {V}_{c} {s}_{c} \vert {H}_{k} , {V}_{c} , {U}_{k} )$$

The previous discussion assumes a perfect knowledge of the CSI at all receivers and identical configurations of all UEs, e.g., all receivers have the same number of antennas, i.e., Mₖ=M∀k.

However, in practical scenarios, the UEs in a system will have different antenna configurations, i.e., the system is heterogeneous and may have different numbers of antennas Mₖ for some or all k, which will significantly reduce the robustness and performance of the communication.

Further, in practical scenarios the actual channel coefficient matrix Hₖ is not known at the receiver, such that the SIC becomes imperfect, yielding a residual interference term due to the CSI error, which leads to a severe degradation of the receiver performance. This interference is represented by the term \tilde{H}ₖV_{c}s_{c} in the following equation, which represents a soft replica y̅ₖ∈ [symbol] ^{M}^{ₖ}^{×1} of the received signal under such imperfect conditions

$${\overline{y}}_{k} = {U}_{k} ( {H}_{k} x + {n}_{k} - {\hat{H}}_{k} {V}_{c} {s}_{c} ) = {\sum }_{{k}^{′} ∈ K} {U}_{k} {H}_{k} {V}_{{k}^{′}} {s}_{{k}^{′}} + {U}_{k} {\tilde{H}}_{k} {V}_{c} {s}_{c} + {U}_{k} {n}_{k}$$

$$with$$

$${H}_{k} = {\tilde{H}}_{k} + {\tilde{H}}_{k} ,$$

where Ĥₖ∈ [symbol] ^{M}^{ₖ}^{×N}^{ₜ} is the imperfectly known, estimated channel coefficient matrix that is shared between the BS and the k-th UE, and \tilde{H}ₖ∈ [symbol] ^{M}^{ₖ}^{×N}^{ₜ} is the corresponding estimated and shared “error” part of the imperfectly known CSI for the communication channel between the BS and the k-th UE. Note that in this specification the expression “estimated and shared” refers to communicating, i.e., sharing, the estimating information by the estimating entity to one or more other entities in the system.

The estimated recovered common and private signal ŝₖ, ŝ_{c}, respectively, in the case of imperfectly known CSI can be reformulated as

$${\hat{s}}_{c} = R e c ( {y}_{k} \vert {\hat{H}}_{k} , {V}_{c} , {U}_{c , k} )$$

$${\hat{s}}_{k} = R e c ( {y}_{k} - {\hat{H}}_{k} {V}_{c} {s}_{c} \vert {\hat{H}}_{k} , {V}_{k} , {U}_{k} )$$

where the estimated channel coefficient matrix Ĥₖ accounts for the imperfectly known CSI. The precoder and combiner matrices V_{c}, Vₖ, U_{c,k}, and Uₖ are designed to incorporate heterogeneity of the number of antennas of the multiple receivers, as will be discussed further below.

The SINR of the private message for the imperfect SIC case is given by

$${Γ}_{k} = {V}_{k}^{H} {H}_{k}^{H} {{U}_{k}^{H} ( {\sum }_{{k}^{′} ∈ 𝒦 \backslash k} {U}_{k} {H}_{k} {V}_{{k}^{′}} {V}_{{k}^{′}}^{H} {H}_{k}^{H} {U}_{k}^{H} + {U}_{k} {\tilde{H}}_{k} {V}_{c} {V}_{c}^{H} {\tilde{H}}_{k}^{H} {U}_{k}^{H} + {σ}_{n}^{2} {I}_{M} )}^{- 1} {U}_{k} {H}_{k} {V}_{k}$$

with

$${U}_{k} {\tilde{H}}_{k} {V}_{c} {V}_{c}^{H} {\tilde{H}}_{k}^{H} {U}_{k}^{H}$$

representing the residual interference due to the imperfect with SIC resulting from the imperfect CSI.

It is readily apparent that practical RSMA systems exhibit a rate loss from such residual interference, on top of the multi-user interference, which is ultimately caused by the imperfectly known CSI at the receiver.

An aspect of the present invention addresses this issue by jointly determining the precoding and combining parameters, or matrices, V and U at the transmitter, or BS, and providing these to the receiver, or UE. Depending on the respective communication protocol used in the communication system the CSI may be determined in the BS or is determined in the UE and provided to the BS for determining the precoding and combining parameters.

The UE uses the precoding and combining parameters, or matrices, for improving the signal estimation and recovery and, thus, for improving the detection of transmit symbols. To this end, it is assumed that the UE accesses the precoding and combining parameters, or matrices, V, U and, if not previously determined in the UE, the estimated CSI used in the transmitter, via ideal feedback.

FIG. 1 shows the main components of a corresponding transmitter, e.g., in a base station 300, and receiver, e.g., in a UE 400, respectively. It is noted that, when the estimated CSI is determined in the UE, the UE provides the CSI to the BS via the same ideal feedback.

In the base station 300, after splitting the signals to be transmitted to the multiple UEs into a common part and multiple corresponding private parts, and after encoding the common and private signals, the resulting signal s is supplied to a precoder 302. A beamformer (BF) 304 supplies a precoding matrix V to the precoder 302, which outputs a signal x that is ultimately transmitted via the multiple antennas 306 of the base station 300. Sending the respective precoded signals over the multiple antennas effectively results in an electronic beamforming of the private parts of the transmission towards the respective receiver. Beamformer 304 jointly determines the precoding matrix V and the combiner matrix U in accordance with estimated channel coefficients provided in channel coefficient matrix Ĥ, determined by a channel estimator 308. As mentioned before, the matrix Ĥ carrying the estimated channel coefficients, the precoding matrix V, as well as a combiner matrix U for use at the respective receiver is transmitted to the UE 400 via an ideal feedback link 399, i.e., can be assumed to be fully available at the UE 400 at the time of decoding the transmitted signal.

At the UE 400 the transmitted signal is received via the multiple antennas 402, and the received signal y is provided to combiners 404a, 404b. Combiner 404a combines the common message part of yₖ, using the combiner matrix U_{c,k}, and outputs a combined received signal y_{c,k} to a decoder 408 configured for decoding the common signal. Combiner 404b combines the private message part of yₖ, using the combiner matrix Uₖ, and outputs a combined received signal Uₖyₖ to an interference cancellation (IC) unit 410, of a detector 406. The combiners use the previously received combiner matrices U for electronic beamforming towards the transmitter. Based on the common signal output from decoder 408 and the combined received signal Uₖyₖ the IC unit 410 determines a version of the received signal having a largely reduced interference, which is provided to a decoder 412 configured for decoding the private signal. Detector 406 outputs an estimated signal ŝ representing the transmitted common and private signal.

Before further describing embodiments of the proposed invention in greater detail, the signal or message flow in the exemplarily assumed communication protocols of the downlink RSMA system, time division duplex (TDD) and frequency division duplex (FDD), respectively, are illustrated in FIGS. 2 and 3.

FIG. 2 shows a swim-lane diagram of the messages exchanged between a BS and a target UE in a TDD communication system in the DL direction, and the respective processing invoked at the respective end. First, the target UE transmits a pilot signal to the BS. The pilot signal may be part of a regular communication transmission from the target UE to the BS. The BS uses the pilot signal for performing CE, i.e., estimating a channel coefficient matrix Ĥ, and determines, in the beamformer, a precoder matrix V, for electronic beamforming towards the target UE by accordingly transmitting appropriate signals via the Nₜ≥1 transmit antennas and the combiner matrix U. The estimated channel coefficient matrix Ĥ, the precoding matrix V and the combiner matrix U output from the BF are fed back to the UE, which stores the matrices for use in decoding received messages. Next, the BS splits the message to be sent into a common part intended for multiple UEs and a private part intended only for the target UE, i.e., produces an RSMA signal. The RSMA signal is then precoded using the precoding matrix V, yielding transmit signals for each of the Nₜ≥1 transmit antennas of the BS, and transmits the transmit signals, which will effectively result in electronic beamforming towards the target UE. The target UE receives the signals transmitted by the Nₜ≥1 transmit antennas of the BS at its Mₖ≥1 antennas and combines the signals, using the precoding matrix V and the combiner matrix U previously received from the BS. After the common and private messages are decoded, they can be combined into the originally sent message.

FIG. 3 shows a swim-lane diagram of the messages exchanged between a BS and a target UE in a FDD communication system in the DL direction, and the respective processing invoked at the respective end. Here, the BS first transmits a pilot signal to the target UE. Similar to the previous protocol discussed with reference to FIG. 2 the pilot signal may be part of a regular communication transmission from the BS to the target UE. The target UE uses the pilot signal for performing CE, i.e., estimating a channel coefficient matrix Ĥ and transmits the estimated channel coefficient matrix Ĥ to the BS. The BS uses the channel coefficient matrix Ĥ for determining, in the beamformer, a precoder matrix V for electronic beamforming towards the target UE by accordingly transmitting appropriate signals via the Nₜ≥1 transmit antennas and the combiner matrix U. The precoding matrix V and the combiner matrix U output from the BF are fed back to the UE, which stores the matrices for use in decoding received messages. Next, the BS splits the message to be sent into a common part intended for multiple UEs and a private part intended only for the target UE, i.e., produces an RSMA signal. The RSMA signal is then precoded using the precoding matrix V, yielding transmit signals for each of the Nₜ≥1 transmit antennas of the BS, and transmits the transmit signals, which will effectively result in electronic beamforming towards the target UE. The target UE receives the signals transmitted by the Nₜ≥1 transmit antennas of the BS at its Mₖ≥1 antennas and combines the signals, using the precoding matrix V and the combiner matrix U previously received from the BS. After the common and private messages are decoded, they can be combined into the originally sent message.

The two exemplary communication protocols briefly discussed above ensure that the BS has all information necessary for determining, in the BF, the precoder matrix V for transmitting to the UEs and the combiner matrix U. Providing information about the precoding matrix V and the combiner matrix U output from the BS to the UEs enables improved signal recovery in the UEs.

As can be seen from the discussion of FIGS. 1 to 3 determining the precoder and combiner matrices in the BF is an important element for the performance of the communication between the BS and the UEs. In accordance with an aspect of the invention the beamformer may be adaptable or configurable, enabling provision of the most suitable precoder and combiner matrices for changing communication requirements and environments.

FIG. 4 shows an exemplary simplified block diagram of such an adaptable and configurable block 304 in the BS that handles the BF design and configures a BF for determining a precoding matrix V and a combiner matrix U required for beamforming in the BS and combining the signals received at the Mₖ≥1 antennas in the UE. In other words, the adaptable and configurable block 304 adaptably designs the BF prior to determining the precoding and combining matrices adapted for the respective communication requirement and environment.

The inputs to BF design block 304 are an estimated channel coefficient matrix Ĥ and a corresponding matrix H̅ representing the error statistics of Ĥ, the outputs are a precoder matrix V and a combiner matrix U that are optimised for one of various specific objectives discussed below. The actual block 304 that generates the output from the input signals is shown as a “black box”, exemplary implementations of which will be discussed hereinafter in greater detail.

The BF design considers three main elements, CSI imperfection incorporation, objective of the beamforming, and design technique. Each of the main elements considered in the BF design may have at least two options or implementations, as exemplarily shown in the following list:

CSI imperfection may be incorporated by
a) Averaging, or
b) Estimating a worst-case channel

The objective of the optimisation may be
a) Total sum rate maximisation,
b) Minimum rate maximisation, or
c) Power consumption minimisation with rate guarantee

The actual optimisation process may invoke one of the following design techniques
a) Convex optimisation, or
b) Tensor decomposition

The simplified block diagram shown in FIG. 4 is presented in more detail in FIG. 5, illustrating the possible combinations of the main elements. Like in FIG. 4 the inputs to BF design block 304 are an estimated channel coefficient matrix Ĥ and a corresponding matrix H̅ representing the error statistics of Ĥ, which are provided to a block 304a. In block 304a error values \tilde{H} for the estimated channel coefficient matrix Ĥ are determined in accordance with a prior selection of the method to be applied. As per the list above, a choice can be made between averaging the CSI error, block 304a-i, or assuming a worst-case CSI error, block 304a-ii.

In block 304b the objective of the optimisation is selected amongst maximising the total sum transmission rate, block 304b-i, maximising the minimum transmission rate, block 304b-ii, and minimising the transmit power while achieving a guaranteed transmission rate, block 304b-iii. Finally, in block 304c, a selection is made whether the precoding matrix V and the combiner matrix U are determined through iterative convex optimisation, block 304c-i, or through tensor decomposition, block 304c-ii. The possible combinations using one of the two alternative options for obtaining estimations of the CSI error statistics, one of the three alternative objectives of the precoding, and one of the two design techniques that can be used for determining the precoding matrix V and the combiner matrix U, based on the exemplary list above, are indicated by the lines connecting the various blocks.

Based on the options or implementations from the exemplary list above, twelve different BF designs for determining the precoding and combining parameters can be obtained:
1. determining RSMA precoder and combiner matrix by applying iterative convex optimisation to maximise total sum-rate under average CSI error
2. determining RSMA precoder and combiner matrix by applying iterative convex optimisation to maximise total sum-rate under worst-case CSI error
3. determining RSMA precoder and combiner matrix by applying iterative convex optimisation to maximise minimum rate under average CSI error
4. determining RSMA precoder and combiner matrix by applying iterative convex optimisation to maximise minimum rate under worst-case CSI error
5. determining RSMA precoder and combiner matrix by applying iterative convex optimisation to minimise power with rate-guarantee under average CSI error
6. determining RSMA precoder and combiner matrix by applying iterative convex optimisation to minimise power with rate-guarantee under worst-case CSI error
7. determining RSMA precoder and combiner matrix by applying tensor decomposition to maximise total sum-rate optimised under average CSI error
8. determining RSMA precoder and combiner matrix by applying Tensor Decomposition to maximise total sum-rate optimised under worst-case CSI error
9. determining RSMA precoder and combiner matrix by applying Tensor Decomposition to maximise minimum rate under average CSI error
10. determining RSMA precoder and combiner matrix by applying Tensor Decomposition to maximise minimum rate under worst-case CSI error
11. determining RSMA precoder and combiner matrix by applying Tensor Decomposition to minimise power with rate-guarantee under average CSI error
12. determining RSMA precoder and combiner matrix by applying Tensor Decomposition to minimise power with rate-guarantee under worst-case CSI error

In accordance with a first aspect of the invention a method of determining a process for generating precoding and/or combining parameters for wireless interfaces of a first and a second communication device, respectively, is provided. The first communication device is configured for wireless communication with a plurality of second communication devices in a MU-MIMO communication system, i.e., each of the first and second wireless communication devices has multiple antennas. The method comprises, for all communication channels with all of the plurality of second communication devices, receiving a selection input for selecting a targeted property of the communication connections, a process for processing respective errors associated with estimated channel coefficient matrices Ĥₖ of all communication channels, and a design technique, respectively. The selection input may be provided through a general communication device configuration, through pre-set configurations for specific message or data types, or the like. The method further comprises selecting, in accordance with the corresponding selection input, one from a plurality of targeted properties of the communication connections, the targeted properties including, inter alia, a maximisation of the total sum rate, i.e., the sum of the rates of all connections between the first communication device and the plurality of second communication devices at any given time, a maximisation of the minimum rate, i.e., maximisation of the lowest or worst-case rate for each of the second communication devices, or the minimisation of the transmitter power consumption while being able to achieve a guaranteed rate. The latter targeted property may result in a guaranteed rate for each of the second communication devices at the lowest transmit power, or in a guaranteed sum rate over all second communication devices at the lowest transmit power, depending on the system requirements. The targeted properties may also be referred to as objectives in this specification, and may be chosen to be valid for all connections originating or terminated at the BS. The method yet further comprises selecting, in accordance with the corresponding selection input, one of a plurality of processes for processing the respective errors associated with the estimated channel coefficient matrices Ĥₖ of all communication channels. The processes for error-processing may include, inter alia, averaging the statistical error or estimating a worst-case error. Averaging may use the expected values of the channel estimation errors for each connection between the first and the one or more second communication devices as input, which depends from the respective SNR of the pilot signal communication and the channel model, e.g.,

$${\overline{H}}_{k} = 𝔼 [ {\tilde{H}}_{k}^{H} {\tilde{H}}_{k} ] ∀ k .$$

The method yet further comprises selecting, in accordance with the corresponding selection input, one of a plurality of design techniques for determining the precoding and/or combining parameters, the design techniques comprising, inter alia, an iterative convex optimisation or a tensor decomposition. Yet further, the method comprises implementing and configuring a process for generating the precoding and/or combining parameters V_{c}, Vₖ, U_{c,k}, and Uₖ in accordance with the selected targeted properties of the communication connection, the selected error-processing, and the selected design technique. The process for generating is configured to use at least the estimated channel coefficient matrices Ĥₖ and the output from the error-processing as inputs. The precoding and/or combining parameters V_{c}, Vₖ, U_{c,k}, and Uₖ may comprise scalar values or may be arranged in vectors or matrices.

In one or more embodiments the method in accordance with the first aspect of the invention is invoked at least in one of the following instances:
at predetermined intervals,
when a new second wireless communication device (400) joins the plurality of second wireless communication devices (400) connected with the first communication device (300),
when one or more of the second wireless communication device (400) leaves the plurality of second wireless communication devices (400) connected with the first communication device (300),
when the channel coefficients for at least one from the plurality of second wireless communication devices (400) connected with the first communication device (300) changes,
and/or when a data message content and/or type to be transmitted to one or more from the plurality of second wireless communication devices (400) connected with the first communication device (300) changes.

It is also possible that any of the first or second wireless devices demands or initiates such invocation. This ensures that the targeted properties can be dynamically adapted to changing requirements. This embodiment may also comprise negotiating or selecting a new targeted property, process for processing the respective errors associated with the estimated channel coefficient matrices Ĥₖ, and/or design technique for determining the precoding and/or combining parameters V_{c}, Vₖ, U_{c,k}, Uₖ. This embodiment may further also comprise negotiating or setting a time when to use the new parameter set. It is obvious that the earliest dynamic adaptation of generating the process is possible only for the next transmission interval.

Implementing the process may comprise providing, e.g., from a non-volatile memory, computer program instructions and/or data which represent a set of target properties of the communication connection, a process for processing the errors of the estimated channel coefficient matrices Ĥk, and a computer-implemented algorithm for determining the precoding and/or combining parameters V_{c}, Vₖ, U_{c,k} and Uₖ.

FIG. 6 shows an exemplary flow diagram of a method 100 in accordance with the first aspect of the present invention. In step 102 a check is made whether or not to invoke the method. In the positive case, “yes”-branch of step 102, a selection input is received, in step 110, for selecting a targeted property of the communication connections, a process for processing respective errors associated with estimated channel coefficient matrices Ĥₖ of all communication channels and a design technique, respectively. In step 120 one from a plurality of sets of target properties for the communication connections is selected in accordance with the selection input. In step 130 one from a plurality of processes for processing the respective errors of the estimated channel coefficient matrices Ĥk is selected in accordance with the selection input. In step 140 one of a plurality of design techniques for determining the precoding and/or combining parameters V_{c}, Vₖ, U_{c,k}, Uₖ is selected in accordance with the selection input. Finally, in step 150, a process for determining the precoding and/or combining parameters V_{c}, Vₖ, U_{c,k}, Uₖ is implemented and configured in accordance with the selected targeted properties of the communication connections, the selected error-processing, and the selected design technique.

In accordance with a second aspect of the invention, a method of generating precoding and/or combining parameters V_{c}, Vₖ, U_{c,k}, and Uₖ for wireless interfaces of a first and a second communication device, respectively, is provided, which is implemented and configured in accordance with the method of the first aspect described before. The first communication device is configured for wireless communication, via multiple antennas, with a plurality of second communication devices likewise having multiple antennas, in a MU-MIMO RSMA communication system. The implemented and configured process applies the selected error processing design technique for iteratively optimising the precoding and combining parameters V_{c}, Vₖ, U_{c,k}, and Uₖ in accordance with the selected target properties. When executing the implemented and configured process, the method comprises receiving, as an input to the implemented and configured process, the estimated channel coefficient matrices Ĥₖ and data on the error statistics thereof, e.g., as respective error matrices H̅ₖ, for all communication channels between the first communication device and each of the plurality of second communication devices, and may also comprise receiving information about the noise power of

$${σ}_{n}^{2}$$

at the respective k-th receiver. The method further comprises processing the errors associated with the respective estimated channel coefficient matrices Ĥₓ in accordance with the implemented and configured process. The method yet further comprises determining and/or optimising precoding and combining parameters V_{c}, Vₖ, U_{c,k}, and Uₖ in accordance with the implemented and configured process and the selected set of target properties for the communication channels, and outputting the optimised precoding and combining parameters V_{c}, Vₖ, U_{c,k}, and Uₖ when a termination criterion of the iteration is met.

In one or more embodiments iteratively determining and optimising precoding and combining parameters V_{c}, Vₖ, U_{c,k}, and Uₖ includes performing an iterative convex optimisation of the precoding and combining parameters V_{c}, Vₖ, U_{c,k}, and Uₖ, or performing a tensor decomposition on the estimated channel coefficient matrix Ĥₖ and a resource allocation on the results thereof prior to determining the precoding and combining parameters V_{c}, Vₖ, U_{c,k}, and Uₖ. Any iteration steps that may be present may be repeated until a corresponding termination criterion is met.

In one or more embodiments in which a tensor decomposition is performed, at least one of the decomposed factors is a set of diagonal matrices, in which at least one spatial position along the diagonal for the common signal is identical in all matrices, and in which the spatial positions along the diagonal for the multiple second wireless devices each have an aggregated overlap below a predetermined value or are mutually exclusive.

In one or more embodiments error-processing includes averaging the error of the estimated channel coefficient matrix Ĥₖ, or estimating a worst-case error \tilde{H}ₖ for the estimated channel coefficient matrix Ĥₖ. Estimating the error may also comprise considering the noise power

$${σ}_{n}^{2} .$$

In one or more embodiments in which a worst-case error \tilde{H}ₖ for the precoding and combining parameters V_{c}, Vₖ, U_{c,k}, Uₖ is determined, the worst-case error \tilde{H}ₖ determined for each iteration is fed back to the iterative convex optimisation or the tensor decomposition, respectively, as an input signal for the next iteration.

The termination criterion may comprise, inter alia, the condition that each of the precoding parameters V_{c} and Vₖ and the combiner parameters U_{c,k} and Uₖ determined in the current iteration is sufficiently close to the respective precoding and combiner matrices determined in the preceding iteration or iterations. The condition of sufficiently close may be fulfilled, e.g., when a normalised change of values in the matrices between a current iteration and the foregoing iteration is smaller than a predefined threshold value, e.g., smaller than 10⁻⁶. When comparing the change in the matrices between more than one successive iterations a trend may be determined thereon, whose extrapolation may be used for setting the threshold value.

Alternatively, the termination criterion may comprise that a worst-case error \tilde{H}ₖ estimated using the precoding parameters V_{c} and Vₖ and the combiner parameters U_{c,k} and Uₖ determined in the current iteration does no longer significantly improve over the worst-case error \tilde{H}ₖ estimated in the preceding iteration or iterations, e.g., the improvement of the worst-case error over one or more previous iterations is smaller than a predetermined threshold value. The condition of no longer significantly improving may be verified based on a normalised change in the worst-case error. When comparing the improvement of the worst-case error \tilde{H}ₖ over that of more than one previous iteration the worst-case error \tilde{H}ₖ for the more than one previous iterations may be averaged, or a trend may be determined thereon, whose extrapolation may set the reference value for the comparison.

A termination criterion of an iterative process, in particular that of a channel tensor decomposition, may also comprise obtaining, for at least one of the decomposed factors, a set of diagonal matrices, in which at least one spatial position along the diagonal for the common signal is identical in all matrices, and in which the spatial positions along the diagonal for the multiple second wireless devices each or altogether have an aggregated overlap below a predetermined value or are mutually exclusive. The criterion of the aggregated overlap being below a predetermined value may include that no single one of the overlapping spatial positions has a value that exceeds a predetermined value.

FIG. 7 shows an exemplary basic flow diagram of a method 200 of generating precoding and combining parameters V_{c}, Vₖ, U_{c,k}, Uₖ in accordance with the second aspect of the present invention, which is implemented and configured in accordance with the method of the first aspect. In step 202 the estimated channel coefficient matrices Ĥₖ and data on the error statistics thereof are received as an input to the implemented and configured process. As a further input to the method the noise power

$${σ}_{n}^{2}$$

at the respective k-th UE may be received. In step 210, which is conditionally invoked depending on the implemented and configured process, the precoding and combining parameters V_{c}, Vₖ, U_{c,k}, and Uₖ are initialised, and in step 220 the error of the respective estimated channel coefficient matrices Ĥₖ is processed in accordance with the implemented process. In steps [230 . . . 280] parameters V_{c}, Vₖ, U_{c,k}, and Uₖ are iteratively determined and optimised in accordance with the implemented process and the selected set of target properties for the communication channels, using the previously received estimated channel coefficient matrix Ĥₖ and data on the error statistics thereof as inputs. When a termination criterion is met, check step 290, the iteration is terminated and the optimised precoding and combining parameters V_{c}, Vₖ, U_{c,k}, and Uₖ are output in step 292. The dashed connection from step 290 to step 220 indicates the iteration loop for those cases in which the error is determined for each iteration. Exemplary embodiments of the method in which the error is determined for each iteration will be discussed further below.

In the following section various specific embodiments of the method in accordance with the second aspect of the invention will be presented.

In a first specific embodiment, the method in accordance with the first aspect of the invention has resulted in the implementation and configuration of a method in accordance with the second aspect of the invention, in which the precoding parameters V_{c} and Vₖ and the combiner parameters U_{c,k} and Uₖ are iteratively optimised through convex optimisation, assuming an averaged CSI error. The optimisation may, inter alia, be implemented as a block coordinate descent process, although other optimisation methods may also be used.

FIG. 8 shows a block diagram of a corresponding first specific exemplary precoder and combiner matrix BF design block implemented in accordance with the method 100 in accordance with the first aspect of the invention. The BF design block applies iterative convex optimisation and assumes an averaged CSI error. The input matrices Ĥ and H̅ are provided to block 304a-i. Block 304a-I initialises the precoding and combiner parameters V and U, respectively, and provides these, as well as the estimated channel coefficient matrix Ĥ and the corresponding average errors [symbol] [\tilde{H}^{H}\tilde{H}], to the optimiser block 304c-i. In optimiser block 304c-i the precoding and combiner parameters V and U are iteratively optimised, indicated by the arrows going forth and back between the update blocks for V and U, and the respective updated parameter or parameter set is provided to the respective other update block. The optimisation is performed in accordance with the objective selected in block 304b, i.e., either maximising the total sum transmission rate, maximising the minimum transmission rate, or minimising the transmit power while achieving a guaranteed transmission rate. The optimisation may, e.g., implement a convex optimisation algorithm. Prior to the optimisation, a block coordinate descent algorithm may be applied for decoupling the optimisation variables V_{c}, Vₖ for the precoder and U_{c,k}, Uₖ for the combiner. Further, prior to the actual optimisation appropriate convexising of a function that algebraically describes the object of the optimisation may be executed, if required. The optimisation is terminated when a termination criterion is met, and the optimised precoding and combiner parameters V and U are output. It is noted that information about the noise power of

$${σ}_{n}^{2}$$

at the respective k-th receiver may also be provided as an input to the BF design block (not shown in the figure).

FIG. 9 shows a flow diagram of a corresponding first specific embodiment of the method 200 of generating precoding and combining parameters V_{c}, Vₖ, U_{c,k}, Uₖ for wireless interfaces of a first (300) and a second (400) communication device, respectively, in accordance with the second aspect of the invention. The method of the first specific embodiment is targeted to optimise the precoding and combining parameters V_{c}, Vₖ, U_{c,k}, Uₖ for the k-th UE while maximising the total rate, assuming an averaged CSI error. This embodiment of the method 200 may comprise, after receiving an estimated and shared CSI represented by Ĥₖ, a corresponding matrix

$${\overline{H}}_{k} = 𝔼 [ {\tilde{H}}_{k}^{H} {\tilde{H}}_{k} ] ∀ k$$

representing the error statistics of Ĥₖ, and variance

$${σ}_{n}^{2}$$

in step 202, the following steps:
210—initialising the precoding parameters V_{c} and Vₖ and the combiner matrices U_{c,k} and Uₖ with Ĥₖ,
212—approximating the total rate Rₜₒₜₐₗ as a function of the estimated and shared CSI represented by Ĥₖ,
214—convexising the approximated function with auxiliary and slack variables,
220—error processing
232—optimising the precoding parameters V_{c} and Vₖ:
   234—solving the convexised approximated problem for V_{c} and Vₖ with fixed auxiliary variables, and
   236—updating the auxiliary variables with fixed V_{c} and Vₖ,
238—check if precoding parameters V_{c} and Vₖ converge, repeat steps 234 and 236 if not,
otherwise
240—optimise the combiner parameters U_{c,k} and Uₖ:
   242—solving the convexised approximated problem for U_{c,k} and Uₖ with fixed auxiliary variables, and
   244—updating the auxiliary variables with fixed U_{c,k} and Uₖ,
246—check if combiner parameters U_{c,k} and Uₖ converge, repeat steps 242 and 246 if not,
otherwise
280—check if the first loop termination criterion is met, output V_{c}, Vₖ, U_{c,k} and Uₖ in step 292 if yes,
otherwise repeat steps [230 . . . 246 and 280].

An exemplary termination criterion may include the condition that each of the converged precoding parameters V_{c} and Vₖ and the converged combiner parameters U_{c,k} and Uₖ are sufficiently close to the respective previously converged precoding and combiner parameters.

In a second specific embodiment, the method in accordance with the first aspect of the invention has resulted in the implementation and configuration of a method in accordance with the second aspect of the invention, in which the precoding parameters V_{c} and Vₖ and the combiner parameters U_{c,k} and Uₖ are iteratively optimised through convex optimisation, assuming a worst-case CSI error. The optimisation may, again, be implemented as a block coordinate descent process although, like in the first specific embodiment, other optimisation methods may also be used.

FIG. 10 shows a block diagram of a corresponding second specific exemplary precoder and combiner matrix BF design block applying iterative convex optimisation under worst-case CSI error. In this scenario, the input matrices Ĥ and H̅ are provided to an initialisation block 303 which uses this input, i.e., the CSI and statistics of the CSI error, for determining initial precoding and combiner parameters V and U, respectively, that are provided to block 304a-ii. Block 304a-ii estimates the channel coefficient matrix Ĥ and the corresponding worst-case channel coefficients \tilde{H}, i.e., the most harmful CSI imperfection, and provides these to the optimiser block 304c-i. The most harmful CSI imperfection can be expressed by minimising the achievable rate. The worst-case channel coefficients \tilde{H}ₖ for the channel coefficient matrix Ĥₖ is determined as

$${\tilde{H}}_{k} = {arg min}_{{\tilde{H}}_{k}} {R}_{total}$$

$$subject to {‖ {\tilde{H}}_{k} ‖}_{F}^{2} \leq 𝔼 [ {\tilde{H}}_{k} {\tilde{H}}_{k}^{H} ] , ∀ k$$

In optimiser block 304c-I the precoding and combiner parameters V and U are iteratively optimised, indicated by the arrows going forth and back between the update blocks for V and U, and the respective updated parameter or parameter set is provided to the respective other update block. The optimisation is performed in accordance with the objective selected in block 304b, i.e., either maximising the total sum transmission rate, maximising the minimum transmission rate, or minimising the transmit power while achieving a guaranteed transmission rate. The optimisation may, e.g., implement a convex optimisation algorithm. Prior to the optimisation, a block coordinate descent algorithm may be applied for decoupling the optimisation variables V_{c}, Vₖ for the precoder and U_{c,k}, Uₖ for the combiner. Further, prior to the actual optimisation appropriate convexising of a function that algebraically describes the object of the optimisation may be executed, if required. The optimisation is terminated when a termination criterion is met. Like in the first specific exemplary precoder and combiner matrix BF design block discussed before, information about the noise power

$${σ}_{n}^{2}$$

at the respective k-th receiver may also be provided as an input to the BF design block (not shown in the figure).

FIG. 11 shows a flow diagram of a corresponding second specific embodiment of the method 200 of generating precoding and combining parameters V_{c}, Vₖ, U_{c,k}, Uₖ for wireless interfaces of a first (300) and a second (US) communication device, respectively, in accordance with the second aspect of the invention. The method 200 may comprise, after receiving an estimated and shared CSI represented by Ĥₖ, a corresponding matrix

$${\overline{H}}_{k} = 𝔼 [ {\tilde{H}}_{k}^{H} {\tilde{H}}_{k} ] ∀ k$$

representing the error statistics of Ĥₖ, and variance

$${σ}_{n}^{2}$$

in step 202, the following steps:
210—initialising the precoding parameters V_{c} and Vₖ and the combiner parameters U_{c,k} and Uₖ with Ĥₖ, H={0},
254—optimising V_{c}, Vₖ, U_{c,k} and Uₖ by iterative alternating optimisation with all cases of \tilde{H}ₖ^{TM}H,
256—estimating worst-case CSI error Hₖ by total rate minimisation with fixed V_{c}, Vₖ, U_{c,k} and Uₖ,
258—updating the set of possible worst-case CSI error H={H, \tilde{H}ₖ}∀k,
280—check if the first loop termination criterion is met, output V_{c}, Vₖ, U_{c,k} and Uₖ in step 292 if yes,
otherwise repeat steps [254 . . . 258 and 280].

The optimisation step 254 may be implemented to optimise the precoding and combining parameters V_{c}, Vₖ, U_{c,k}, Uₖ for the k-th UE in accordance with any of the selected targeted properties of the communication connections, including total sum rate maximisation, minimum rate maximisation, or power minimisation with rate guarantee. Similar to the first specific embodiment described before, the optimisation may, e.g., implement a convex optimisation algorithm. Prior to the optimisation, a block coordinate descent algorithm may be applied for decoupling the optimisation variables V_{c}, Vₖ for the precoder and U_{c,k}, Uₖ for the combiner. Further, prior to the actual optimisation appropriate convexising of a function that algebraically describes the object of the optimisation may be executed, if required. The optimisation is terminated when a termination criterion is met, and the optimised precoding and combiner matrices V and U are output.

Determining the worst-case CSI error in each iteration, using the latest precoding and combining parameters V_{c}, Vₖ, U_{c,k}, and Uₖ ensures that the best available precoding and combining parameters V_{c}, Vₖ, U_{c,k}, Uₖ are ultimately found.

An exemplary first loop termination criterion may include the condition that each of the precoding parameters V_{c} and Vₖ and the combiner parameters U_{c,k} and Uₖ are sufficiently close to the respective previously converged precoding and combiner parameters. An alternative exemplary termination criterion may include the condition that an improvement of a worst-case error \tilde{H}ₖ estimated using the precoding parameters V_{c}, Vₖ and the combiner parameters U_{c}, Uₖ determined in the current iteration over a worst-case error \tilde{H}ₖ determined in the preceding iteration or iterations is smaller than a predetermined threshold.

In a third specific embodiment, the method in accordance with the first aspect of the invention has resulted in the implementation and configuration of a method in accordance with the second aspect of the invention, in which the precoding parameters V_{c} and Vₖ and the combiner parameters U_{c,k} and Uₖ are iteratively and jointly optimised through channel tensor decomposition, assuming an averaged CSI error.

This specific embodiment of determining the precoding and combiner parameters V and U, respectively, is derived from the idea of multi-linear generalized singular value decomposition (ML-GSVD), e.g., as proposed by L. Khamidullina, A. L. F. de Almeida, and M. Haardt in “Multilinear generalized singular value decomposition (ML-GSVD) with application to coordinated beamforming in multi-user MIMO systems,” Proc. IEEE ICASSP, Barcelona, Spain, 2020, pp. 4587-4591.

Applying the general principles of ML-GSVD the matrix Hₖ representing the channel coefficients for the k-th UE can be decomposed into the product of the matrices Bₖ, Cₖ and A^{T}, as shown in FIG. 12. FIG. 12 shows multiple so-called “slices”, each slice dimension exemplarily representing a channel coefficient matrix and the decomposed factors, respectively, for one of the k UEs. A^{T} is a square matrix similar to the right singular vectors of a conventional singular value decomposition (SVD) except for the fundamental difference that it is common to all slices of Hₖ. It is, therefore, represented only once. Bₖ is a rectangular unitary matrix for each individual slice, akin to the left singular vectors in a conventional SVD. Cₖ is a diagonal matrix for each individual slice, representing channel spaces occupied by each UE. The channel spaces represented by the diagonal matrix Cₖ may comprise information about the dimensions of the antennas.

The most important aspect in designing the BF in space division multiple access (SDMA) systems is the structure of the decomposed channel, especially the diagonal matrices Cₖ, and exclusive dimension allocation, i.e., space allocation. However, the known ML-GSVD method is not designed to promote the separation of the subspaces of the common interface matrix A^{T}, a drawback that clearly does not facilitate the construction of TX beamformers. This issue has been addressed by K. Ando, H. limori, G. T. F. de Abreu and K. Ishibashi in “User-Heterogeneous Cell-Free Massive MIMO Downlink and Uplink Beamforming via Tensor Decomposition,” IEEE Open Journal of the Communications Society, vol. 3, pp. 740-758, 2022, in which a new tensor decomposition is proposed. The new tensor decomposition promotes the orthogonalization of the subspaces in A by means of a procedure that enforces the sparsity in the matrix C, yielding complete separation of all subspaces in A, enabling interference-free BFs in the underloaded case. A corresponding decomposition is exemplarily shown in FIG. 13, where the non-zero positions along the diagonals of Cₖ, indicated by the solid black filling of the matrix positions, are ordered or grouped, for each of the k channels, such that the superposition of the matrices Cₖ does not result in overlapping of these non-zero positions.

While the orthogonalised subspaces as proposed in prior art methods are generally beneficial for beamforming in MU-MIMO environments, RSMA has specific requirements, in particular due to the common message parts, that are as yet not properly addressed.

Thus, an aspect of the present invention also proposes a new tensor decomposition that divides the channel space into respective spaces for “common messages” and “private messages”. With this new decomposition, the channel structure can be illustrated as shown in FIGS. 14 and 15. In the figures the channel spaces for the common messages are identified by the places in the matrices filled with diagonal hash pattern, while the channel spaces for the private messages are identified by the solid black filling. FIG. 15 shows a magnified representation of the matrices Cₖ, in which the channel spaces for the common and private messages are indicated. The diagonal matrices Cₖ now have overlapping common spaces for the common messages, which is possible since the common signal is common to all UEs. The private messages, however, have mutually exclusive spaces, for reducing interference with respective other UEs private messages.

This further separation finally takes the specific requirements of the RSMA system into account, i.e., the separation of common and private message parts, and permits jointly determining precoding and combiner parameters V_{c}, Vₖ, U_{c,k} and Uₖ, respectively, for beamforming at the transmitter and receiver, respectively, that enables interference-free RSMA communication.

FIG. 16 shows a block diagram of a corresponding third specific exemplary precoder and combiner BF design block applying channel tensor decomposition and assuming an averaged CSI error. The input matrices Ĥ and H̅ are provided to block 304a-i. Block 304a-i determines the averaged CSI error [symbol] [\tilde{H}^{H}\tilde{H}] and provides the estimated channel coefficient matrix Ĥ, the averaged CSI error and an initial BF to the tensor decomposition block 304c-ii. Tensor decomposition block 304c-ii, after initialisation in block 260, performs tensor decomposition by iterative updating of each factor B, C, A in the respective blocks 264, 266 and 268. The iterative channel tensor decomposition is terminated when the channel tensors no longer converge, and the factors B, C, A are output. Using the result of the decomposition, the resource allocation and the actual BF design is employed for achieving the objective previously selected in block 304b, i.e., either maximising the total sum transmission rate, maximising the minimum transmission rate, or minimising the transmit power while achieving a guaranteed transmission rate. Like in the first and second specific exemplary precoder and combiner matrix BF design blocks discussed before, information about the noise power

$${σ}_{n}^{2}$$

at the respective k-th receiver may also be provided as an input to the BF design block (not shown in the figure).

FIG. 17 shows a flow diagram of an according third specific embodiment of the method 200 of generating precoding and combining parameters V_{c}, Vₖ, U_{c,k}, Uₖ for wireless interfaces of a first (300) and a second (US) communication device, respectively, in accordance with the second aspect of the invention. This embodiment of the method 200 may comprise, after receiving an estimated and shared CSI represented by Ĥₖ, a corresponding matrix

$${\overline{H}}_{k} = 𝔼 [ {\tilde{H}}_{k}^{H} {\tilde{H}}_{k} ] ∀ k$$

representing the error statistics of Ĥk, and variance

$${σ}_{n}^{2}$$

in step 202, the following steps:
210—initialising the variables for the decomposition of the channel tensor

$$H = [ {H}_{1} , … , {H}_{k} ] ,$$

262—decomposing the channel tensor into three factors A, C, and Bₖ, ∀k,
   264—updating Bₖ with fixed A and C,
   266—updating C with fixed A and Bₖ,
   268—updating A with fixed C and Bₖ,
280—check if the first loop termination criterion is met, otherwise repeat steps [264 . . . 268],
270—perform resource allocation by computing transmit power and stream allocation to all UEs,
272—compute V_{c}, Vₖ, U_{c,k} and Uₖ,
292—output V_{c}, Vₖ, U_{c,k} and Uₖ.

An exemplary first loop termination criterion for the channel tensor decomposition may comprise obtaining, for at least one of the decomposed factors, a set of diagonal matrices, in which at least one spatial position for the common signal along the diagonal is identical in all slices, and in which the spatial positions for the private signals of the multiple second wireless devices along the diagonal each or altogether have an aggregated overlap below a predetermined value or are mutually exclusive.

The selected error processing, here averaging the error of the estimated channel coefficient matrix Ĥₖ, is performed prior to the channel tensor decomposition, and is part of the initialising step 210. The channel tensor decomposition considers the result of the processing of the error of the estimated channel coefficient matrix Ĥₖ and may also consider the selected targeted properties of the communication connections with the second communication devices.

The resource allocation step 270 may be implemented to optimise the precoding and combining parameters V_{c}, Vₖ, U_{c,k}, Uₖ for the k-th UE in accordance with any of the selected targeted properties of the communication connections, including total sum rate maximisation, minimum rate maximisation, or power minimisation with rate guarantee. To this end the resource allocation may comprise allocating resources to the multiple antennas of the first communication device in accordance with at least one of the decomposed factors, e.g., the diagonal matrix Cₖ.

In a fourth specific embodiment, the method in accordance with the first aspect of the invention has resulted in the implementation and configuration of a method in accordance with the second aspect of the invention, in which the precoding parameters V_{c} and Vₖ and the combiner parameters U_{c,k} and Uₖ are iteratively and jointly optimised through channel tensor decomposition, assuming a worst-case CSI error estimation. Using the same concept of the tensor decomposition presented in the third specific embodiment considering the estimated worst-case CSI error more robust precoding and combining parameters V_{c}, Vₖ, U_{c,k}, Uₖ can be obtained.

FIG. 18 shows a block diagram of an according fourth specific exemplary precoder and combiner BF design block applying tensor decomposition under worst-case CSI error. The estimated channel coefficient matrix Ĥ is provided to tensor decomposition block 304c-ii which, after initialisation in block 260, performs tensor decomposition by iterative updating of each factor B, C, A in the respective blocks 264, 266 and 268. The iterative channel tensor decomposition is terminated when the channel tensors no longer converge, and the factors B, C, A are output. Using the result of the decomposition, the resource allocation and BF design is employed according to the objective previously selected in block 304b, i.e., either maximising the total sum transmission rate, maximising the minimum transmission rate, or minimising the transmit power while achieving a guaranteed transmission rate. The result of the BF design, i.e., the precoding and combiner parameters V and U, respectively, are provided, along with the CSI error matrix H, to block 304a-ii, for estimating the corresponding worst-case channel coefficients H, i.e., the most harmful CSI imperfection, which are fed back to the iterative tensor decomposition. The most harmful CSI imperfection can be expressed by minimising the achievable rate, as discussed further above in connection with the second specific embodiment. The iterative optimisation is terminated when a termination criterion is met. Like in the first through third specific exemplary precoder and combiner matrix BF design blocks discussed before, information about the noise power

$${σ}_{n}^{2}$$

at the respective k-th receiver may also be provided as an input to the BF design block (not shown in the figure).

The initial decomposition and worst-case error estimation can be based on the input signal of the estimated CSI and the error statistics thereof. Once the initial decomposition is completed the resource allocation can be carried out and the precoding and combiner parameters V and U, respectively, can be calculated, considering the objective of the resource allocation.

An exemplary termination criterion may include the condition that each of the precoding parameters V_{c} and Vₖ and the combiner parameters U_{c,k} and Uₖ are sufficiently close to the respective previously converged precoding and combiner matrices. An alternative exemplary termination criterion may include the condition that an improvement of a worst-case error \tilde{H}ₖ estimated using the precoding parameters V_{c}, Vₖ and the combiner parameters U_{c,k}, Uₖ determined in the current iteration over a worst-case error \tilde{H}ₖ determined in the preceding iteration or iterations is smaller than a predetermined threshold.

FIG. 19 shows a flow diagram of a corresponding fourth specific embodiment of the method 200 of generating precoding and combining parameters V_{c}, Vₖ, U_{c,k}, Uₖ for wireless interfaces of a first (300) and a second (US) communication device, respectively, in accordance with the second aspect of the invention. This embodiment of the method 200 may comprise, after receiving an estimated and shared CSI represented by Ĥk, a corresponding matrix

$${\overline{H}}_{k} = 𝔼 [ {\tilde{H}}_{k}^{H} {\tilde{H}}_{k} ] ∀ k$$

representing the error statistics of Ĥₖ, and variance

$${σ}_{n}^{2}$$

in step 202, the following steps:
210—initialising the variables for the decomposition of the channel tensor H=[H₁, . . . , Hₖ], initialising the precoding parameters V_{c} and Vₖ and the combiner parameters U_{c,k} and Uₖ with Ĥₖ, H={0}, and determining an initial worst-case of \tilde{H}ₖ^{TM}H,
262—decomposing the channel tensor into three factors A, C, and Bₖ, ∀k for the worst case of \tilde{H}ₖ^{TM}H
   264—updating Bx with fixed A and C,
   266—updating C with fixed A and Bₖ,
   268—updating A with fixed C and Bₖ,
280—check if the first loop termination criterion is met, otherwise repeat steps [264 . . . 268, 280],
270—perform resource allocation by computing transmit power and stream allocation to all UEs,
272—compute V_{c}, Vₖ, U_{c,k} and Uₖ,
274—estimating worst-case CSI error matrix \tilde{H}ₖ by total rate minimisation with fixed V_{c}, Vₖ, U_{c,k} and Uₖ,
276—update the set of possible worst-case CSI error H={H, \tilde{H}ₖ}, ∀k,
290—check if the second loop termination criterion is met, otherwise update worst-case CSI errors in step 258 and repeat steps [264 . . . 268, 280, 270, 272, 256 and 290],
292—output V_{c}, Vₖ, U_{c,k} and Uₖ.

Like in the third specific embodiment discussed above an exemplary first loop termination criterion for the channel tensor decomposition may comprise obtaining, for at least one of the decomposed factors, a set of diagonal matrices, in which at least one spatial position for the common signal along the diagonal is identical in all slices, and in which the spatial positions for the private signals of the multiple second wireless devices along the diagonal each or altogether have an aggregated overlap below a predetermined value or are mutually exclusive.

An exemplary second loop termination criterion may include the condition that each of the precoding parameters V_{c} and Vₖ and the combiner parameters U_{c,k} and Uₖ are sufficiently close to the respective previously converged precoding and combiner parameters, while maintaining a maximum achievable total rate under worst-case CSI error conditions.

In accordance with a third aspect of the invention, a method of operating a first wireless communication device is presented. The first communication device, e.g., a base station 300, is configured for wireless communication with a plurality of second communication devices 400 in a MU-MIMO RSMA communication system, i.e., each of the first and second wireless communication devices 300, 400 has multiple antennas 306, 402. The method, exemplarily shown in FIG. 21, comprises, in step 504a, executing the method in accordance with the first aspect of the invention and the generating process in accordance with the second aspect of the invention. Alternatively, in step 504b, the method may comprise receiving precoding and combining parameters V_{c}, Vₖ, U_{c,k} and Uₖ determined in accordance with the second aspect of the invention. The alternative steps are indicated by the dashed outlines. The method further comprises providing, in step 506, at least the precoding and combining parameters V_{c}, Vₖ, U_{c,k}, Uₖ to a precoder 302 of the first communication device 300 and at least to each of the plurality of second wireless devices 400 to which messages are to be transmitted. Further, the method comprises, in the first communication device 300, splitting messages to be transmitted to one or more from the plurality of second wireless communication devices 400 into respective common parts and private parts and providing the split messages to the precoder 302 in step 508, and precoding each of the private parts and the common parts in step 510, for obtaining transmission signals for each of a plurality of antennas of the first wireless communication device BS. Finally, the method comprises transmitting the precoded transmission signals in step 512.

In one or more embodiments the method in accordance with the third aspect of the invention further comprises receiving, in step 502 and as an input to the executing step 504a, estimated channel coefficient matrices Ĥₖ and data on the error statistics thereof, for all communication channels between the first communication device 300 and the second communication devices UE. Receiving may comprise determining the estimated channel coefficient matrices Ĥₖ and data on the error statistics thereof at the first wireless communication device 300, or receiving said information from the respective second wireless communication devices 400.

In accordance with a fourth aspect of the invention, a method of operating a second wireless communication device is presented. The second communication device, e.g., a user equipment 400, is configured for wireless communication with a first communication device, e.g., a base station 300, in a MU-MIMO RSMA communication system, i.e., each of the first and second wireless communication devices 300, 400 has multiple antennas 306, 402. The method, exemplarily shown in FIG. 22, comprises receiving, in step 606, at least the precoding and combining parameters V_{c}, Vₖ, U_{c,k}, Uₖ from the first communication device 300, and receiving, in step 608, a signal from the first communication device 300 at the plurality of antennas 402, which signal comprises a common signal part s_{c} and a private signal part sₖ and which was precoded in accordance with the same precoding and combining parameters V_{c}, Vₖ, U_{c,k}, Uₖ previously received from the first communication device 300. The method further comprises combining, in step 610, the respective common and private signal parts s_{c}, sₖ received at the plurality of antennas 402 using the previously received precoding and combining parameters (V_{c}, Vₖ, U_{c,k}, Uₖ) that were used for precoding. The combining step 610 yields combined common signal parts s_{c} and combined private signal parts sₖ, which are provided to a detector 406 in step 612. In step 614 detector 406 estimates the transmitted common and private signal parts s_{c}, sₖ, respectively, and provides the estimated signals at an output in step 622.

In one or more embodiments of the method in accordance with the fourth aspect of the invention, in which the channel coefficient matrix Ĥₖ is estimated by the second wireless communication device and is transmitted to the first wireless communication device, the method further comprises, prior to receiving in step 606 at least the precoding and combining parameters V_{c}, Vₖ, U_{c,k}, Uₖ from the first communication device, estimating at least a channel coefficient matrix Ĥₖ for the communication channel between the second wireless communication device and the first wireless communication device in step 602. The estimated channel coefficient matrix Ĥₖ is then transmitted to the first wireless communication device in step 604.

Estimating, in step 614, the transmitted common and private signals s_{c}, sₖ, respectively, may comprise detecting the common signal part s_{c} from the received signal yₖ, and obtaining the private signal part sₖ using the knowledge of the common signal part s_{c}.

In one or more embodiments the method in accordance with the fourth aspect of the invention the estimating step 614 in the detector 406 comprises decoding the common signal part s_{c} in a first decoder 408 in step 616. In step 618 an interference cancellation is performed, using the decoded common signal part s_{c} and the combined common signal parts s_{c} and combined private signal parts sₖ obtained from the combining step 610 as inputs. The signal output from the interference cancellation step 618 is provided to a second decoder 410, which decodes, in step 620, the private signal part sₖ from the signal obtained by the interference cancellation.

In the various embodiments presented above, estimating a channel coefficient matrix Ĥₖ may comprise any known channel estimation method, including, but not limited to channel estimation based on basis expansion modelling and the like.

In accordance with a fifth aspect of the invention, a wireless communication device, e.g., a base station or a user equipment, comprises one or more microprocessors, volatile and non-volatile memory, and wireless interface circuitry configured for transmitting and/or receiving electromagnetic signals via multiple antennas. The various elements are communicatively connected via one or more data or signal lines or buses. The non-volatile memory stores computer program instructions which, when executed by the microprocessor, configure the wireless device to execute one or more of the methods in accordance with the first, second, third or fourth aspect of the invention as presented above.

The methods described hereinbefore may be represented by computer program instructions. Accordingly, a computer program product comprises computer program instructions which, when executed by a microprocessor of a transmitter, cause the microprocessor to execute methods and to accordingly control hardware components of the transmitter of an RSMA MU-MIMO communication system in accordance with the first, second, or third aspect of the invention as presented above. When executed by a microprocessor of a receiver, the computer program instructions cause the microprocessor to execute methods and to accordingly control hardware components of the receiver of an RSMA MU-MIMO communication system in accordance with the fourth aspect of the invention as presented above.

The computer program instructions may be retrievably stored or transmitted on a computer-readable medium or data carrier. The medium or the data carrier may by physically embodied, e.g., in the form of a hard disk, solid state disk, flash memory device or the like. However, the medium or the data carrier may also comprise a modulated electro-magnetic, electrical, or optical signal that is received by the computer by means of a corresponding receiver, and that is transferred to and stored in a memory of the computer.

An aspect of the present invention advantageously permits joint determination of precoding and combiner matrices in a transmitter, taking imperfect knowledge of the CSI and the specific requirements of RSMA into account. This results in an enhanced robustness of the communication, improved IC at the receiver and ultimately improved symbol detection, without changing the structure of the communication system at all. The adaptability of the BF design provides various ways to ensure a resilient, robust and reliable communication.

The proposed methods can advantageously be used in general wireless communication systems using RSMA in the downlink, in particular in systems having heterogeneous UEs with different numbers of antennas, and generally in any such system where the UEs do not have perfect SIC. However, since the RSMA model harmonises known conventional OMA and NOMA access methods, the proposed method is applicable to any conventional downlink wireless communication system including OMA or NOMA.

The proposed methods may be advantageously used in highly mobile devices, such as vehicles, trains, planes and the like.

### BRIEF DESCRIPTION OF THE DRAWING

The figures in the attached drawing are used for detailing aspects of the present invention. In the drawing

FIG. 1 shows main components of a transmitter, e.g., in a base station 300, and a receiver, e.g., in a UE, respectively, configured for executing the methods according to an aspect of the present invention,

FIG. 2 shows a swim-lane diagram of the messages exchanged between a BS and a target UE in a TDD communication system in the DL direction, and the respective processing invoked at the respective end,

FIG. 3 shows a swim-lane diagram of the messages exchanged between a BS and a target UE in a FDD communication system in the DL direction, and the respective processing invoked at the respective end,

FIG. 4 shows an exemplary simplified block diagram of a block in the BS that handles the BF design and outputs the precoding matrix V and the combiner matrix U required for beamforming in the BS and combining the signals received at the M≥1 antennas in the UE,

FIG. 5 shows a more detailed view of the block handling the BF design shown in FIG. 4,

FIG. 6 shows an exemplary flow diagram of a method in accordance with the first aspect of the present invention,

FIG. 7 shows an exemplary basic flow diagram of a method of generating precoding and combining parameters V_{c}, Vₖ, U_{c,k}, Uₖ in accordance with the second aspect of the present invention,

FIG. 8 shows a block diagram of a first specific exemplary precoder and combiner BF design block applying convex optimisation and assuming an averaged CSI error,

FIG. 9 shows a flow diagram of a corresponding first specific embodiment of the inventive method, for optimising the precoder V for the k-th UE targeted to maximise the total rate,

FIG. 10 shows a block diagram of a second specific exemplary precoder and combiner BF design block applying convex optimisation under worst-case CSI error

FIG. 11 shows a flow diagram of a corresponding second specific embodiment of the inventive method, for optimising the precoder V for the k-th UE targeted to maximise the total rate,

FIG. 12 shows a general representation of matrices and their factors after being submitted to a ML-GSVD operation,

FIG. 13 shows a representation of matrices and their factors after being submitted to a ML-GSVD operation tailored for separated subspaces,

FIG. 14 shows a representation of matrices and their factors after being submitted to a ML-GSVD operation tailored for RSMA with separated subspaces

FIG. 15 shows a magnified representation of the matrices Cₖ of FIG. 14,

FIG. 16 shows a block diagram of a third specific exemplary precoder and combiner BF design block applying tensor decomposition and assuming an averaged CSI error,

FIG. 17 shows a flow diagram of an according third specific embodiment of the inventive method, for optimising the precoder V and the combiner U for the k-th UE targeted to maximise the total rate,

FIG. 18 shows a block diagram of an fourth specific exemplary precoder and combiner BF design block applying tensor decomposition under worst-case CSI error,

FIG. 19 shows a flow diagram of an according fourth specific embodiment of the inventive method, for optimising the precoder V and the combiner U for the k-th UE targeted to maximise the total rate,

FIG. 20 shows a block diagram of a transmitter or receiver configured for executing the methods in accordance with an aspect of the invention,

FIG. 21 shows an exemplary flow diagram of a method of operating a first wireless communication device wirelessly connected to a plurality of second wireless communication devices in a MU-MIMO RSMA communication system, and

FIG. 22 shows an exemplary flow diagram of a method of operating a second wireless communication device wirelessly connected to a first wireless communication device in a MU-MIMO RSMA communication system.

In the figures, identical or similar elements may be referenced using the same reference designators.

### DETAILED DESCRIPTION OF EMBODIMENTS

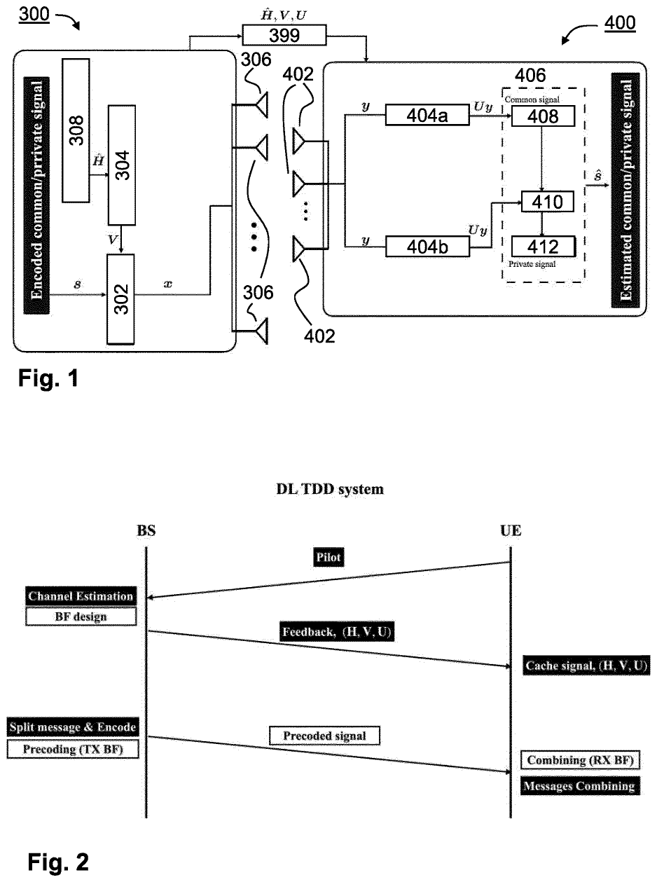

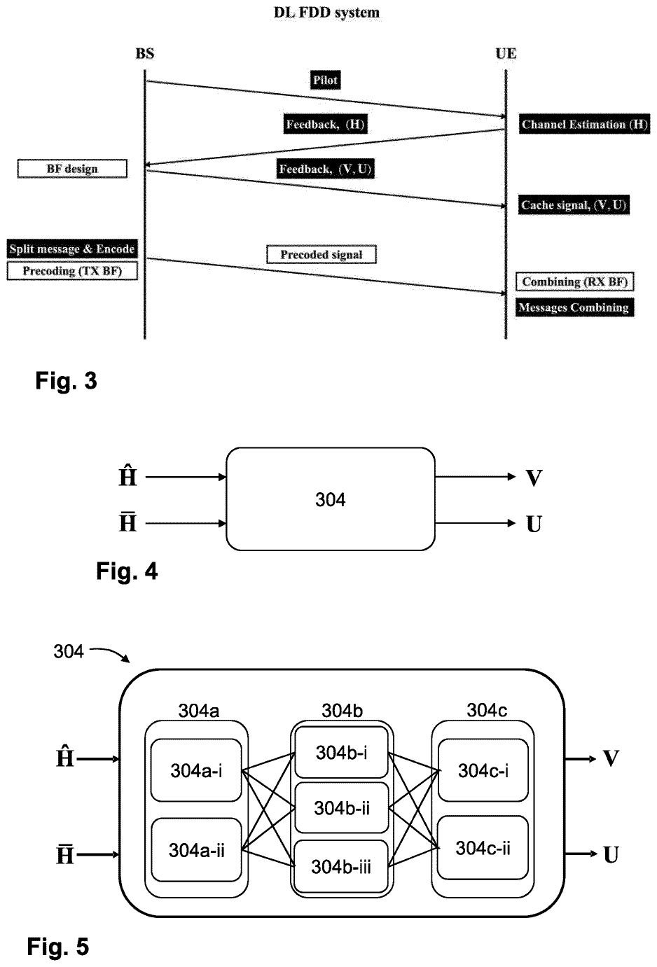

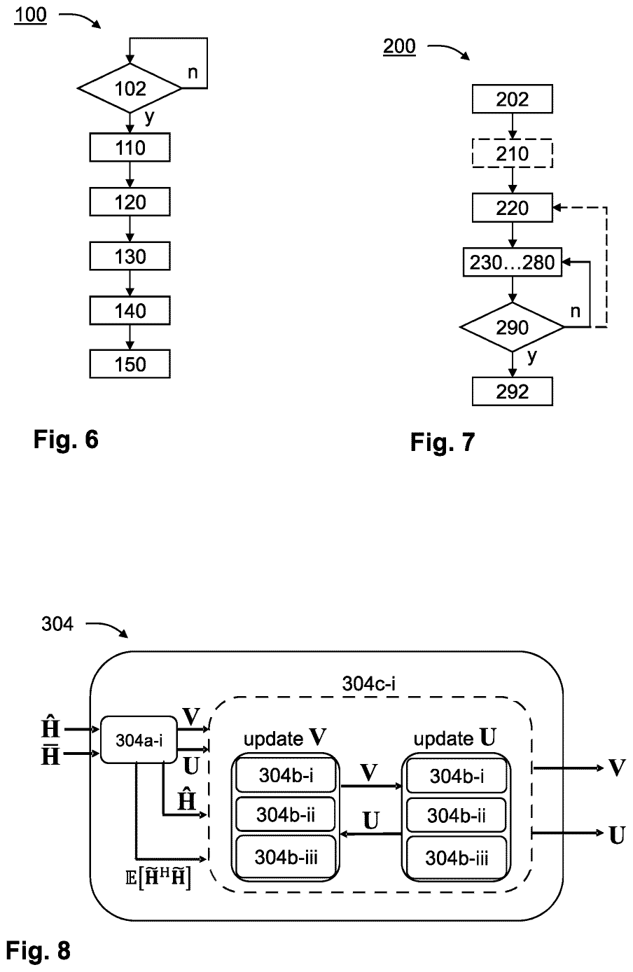

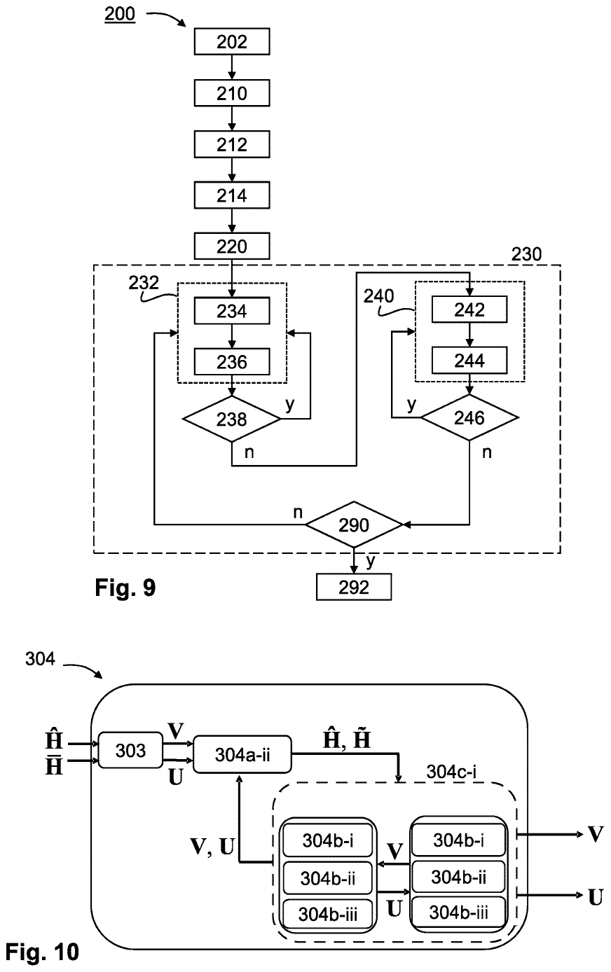

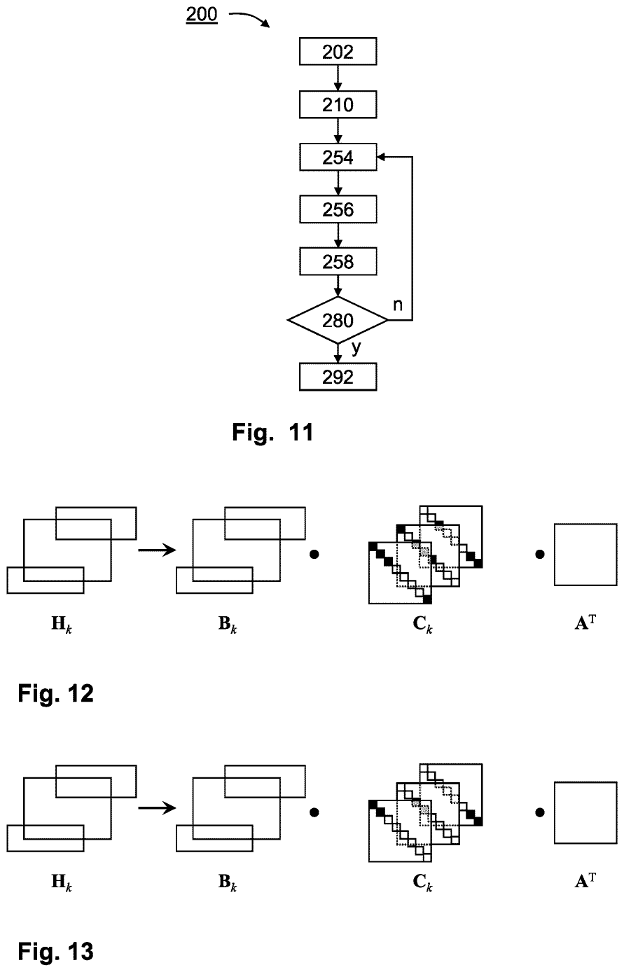

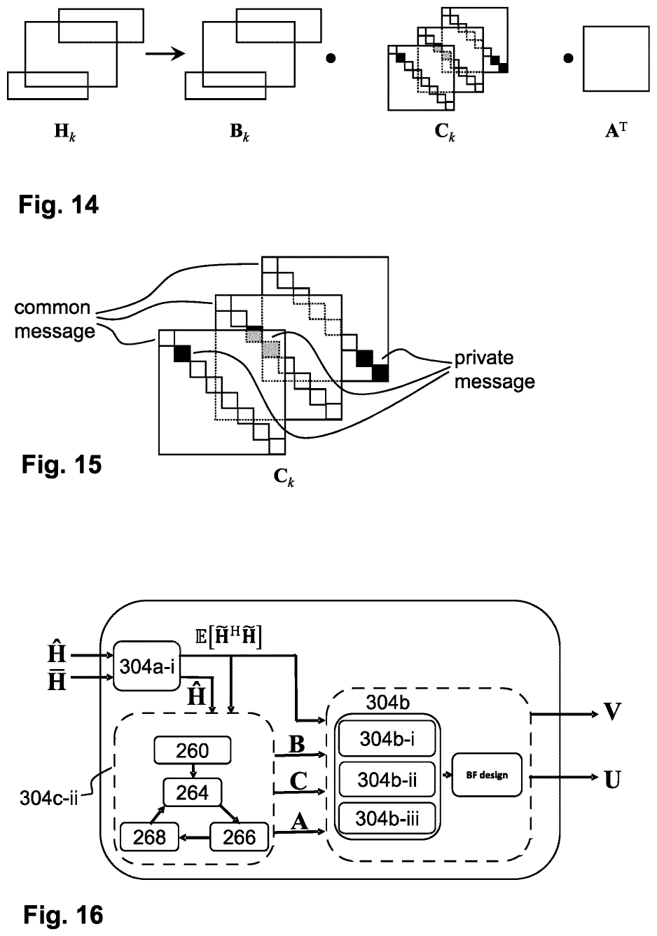

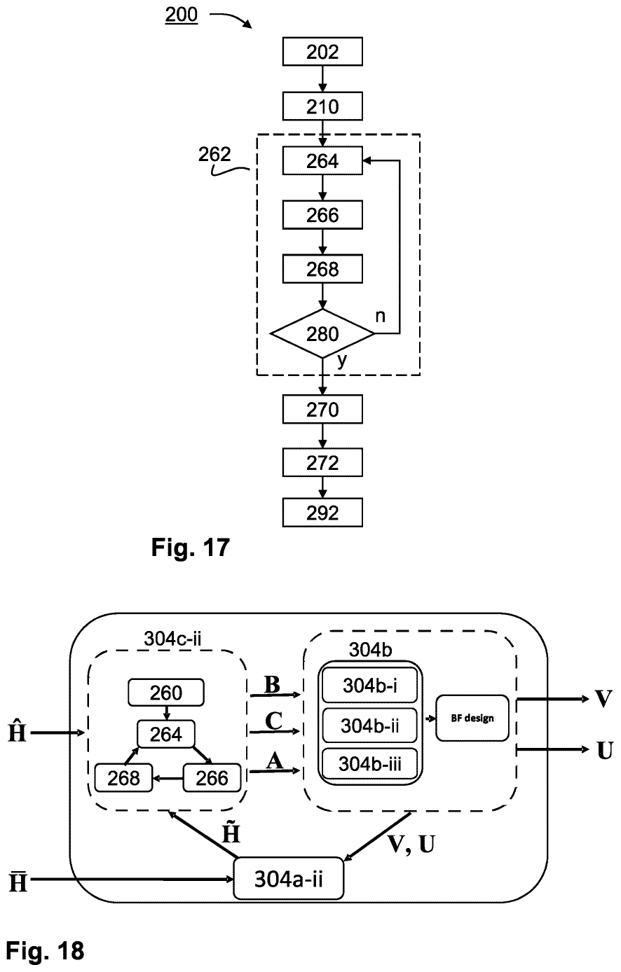

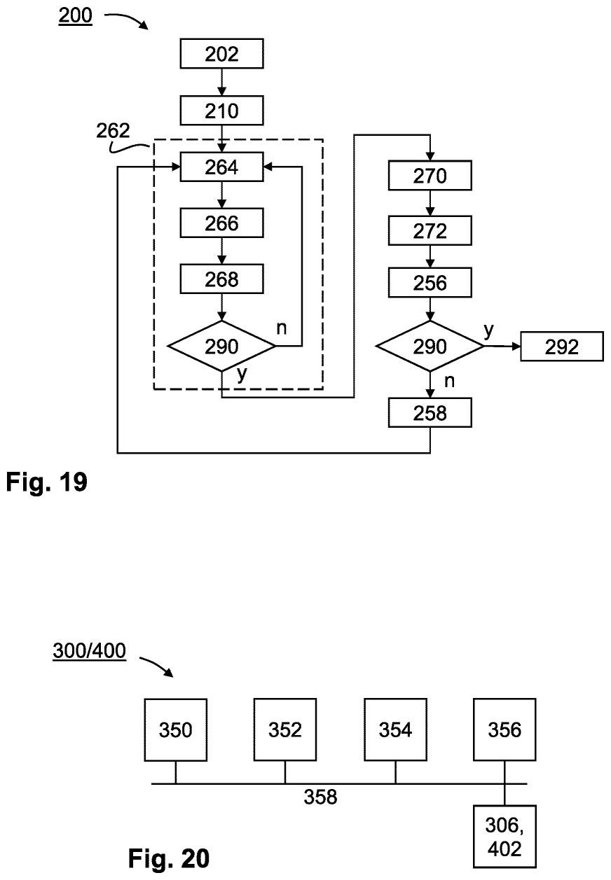

FIGS. 1 to 19 have been described further above and will not be discussed again.

FIG. 20 shows an exemplary block diagram of a transmitter 300 or a receiver 400, respectively, in accordance with embodiments of the fifth aspect of the present invention. The transmitter 300 or receiver 400 comprises a microprocessor 350, a volatile memory 352, a non-volatile memory 354, a wireless interface circuitry 356 configured for communicating with a receiver or a transmitter, respectively, by transmitting and/or receiving electromagnetic signals via multiple antennas 306, 402. The aforementioned elements are communicatively connected via one or more signal or data connections or buses 358. The non-volatile memory 354 stores computer program instructions which, when executed by the microprocessor 350, cause the transmitter 300 or receiver 400 to execute the method according to the first, second or third aspect of the present invention as presented herein.

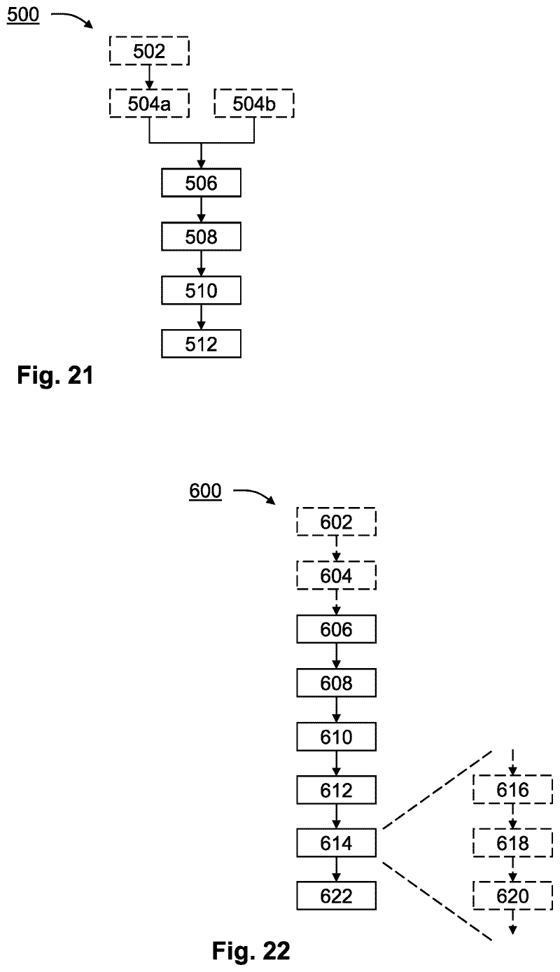

FIG. 21 shows an exemplary flow diagram of a method in accordance with the third aspect of the invention of operating a first wireless communication device 300 in accordance with the fifth aspect of the invention. The first wireless communication device 300 is wirelessly connected to a plurality of second wireless communication devices 400 in a MU-MIMO RSMA communication system. In step 502 estimated channel coefficient matrices Ĥₖ and data on the error statistics thereof, for all communication channels between the first communication device 300 and the second communication devices 400, are received, and provided to step 504a as an input. In step 504a the method of determining a process for generating precoding and combining parameters and the method of generating according to the first and second aspects of the invention are executed. Alternatively, precoding and combining parameters determined in accordance with the method according to the second aspect of the invention are received in step 504b. In step 506 at least the precoding and combining parameters are provided to a precoder 302 of the first communication device 300 and at least to each of the plurality of second wireless devices 400, to which messages are to be transmitted. In step 508 the messages to be transmitted to one or more from the plurality of second wireless communication devices 400 are split into respective common signal parts s_{c} and private signal parts sₖ and are provided to the precoder 302. Precoder 302 precodes, in step 510, each of the private signal parts sₖ and the common signal parts s_{c}, for obtaining transmission signals for each of a plurality of antennas of the first wireless communication device 300. Finally, the precoded transmission signals are transmitted in step 512.

FIG. 22 shows a flow diagram of a method 500 of operating a second wireless communication device 400 wirelessly connected to a first wireless communication device 300 in a MU-MIMO RSMA communication system. Depending on which wireless device estimates the channel coefficient matrix Ĥₖ for the communication channel between the second wireless communication device 400 and the first wireless communication device 300, steps 602 and 604 may optionally be performed, in which said channel coefficient matrix Ĥₖ is estimated and transmitted to the first wireless communication device 300. The method comprises, in step 606, receiving at least precoding and combining parameters V_{c}, Vₖ, U_{c,k}, Uₖ from the first communication device 300. The method further comprises receiving a signal yₖ from the first communication device 300 in step 608. The signal comprises a common signal part s_{c} and a private signal part sₖ and is precoded in accordance with the same precoding and combining parameters V_{c}, Vₖ, U_{c,k}, Uₖ previously received from the first communication device 300. The method yet further comprises, in step 610, combining the respective common and private signal parts received at the plurality of antennas 402 using the previously received precoding and combining parameters V_{c}, Vₖ, U_{c,k}, Uₖ that were used for precoding, for obtaining combined common signal parts s_{c} and combined private signal parts sₖ. The combined common signal parts s_{c} and combined private signal parts sₖ are provided, in step 612, to a detector 406, for estimating, in step 614 the transmitted common and private signal parts s_{c}, sₖ, which are provided at an output in step 622.

Estimating step 614 may comprise decoding the common signal part s_{c} in a first decoder 408 in step 616, performing an interference cancellation in step 618, using the decoded common signal part s_{c} and the combined common signal parts s_{c} and combined private signal parts sₖ obtained from the combining step 610 as inputs, and decoding, in step 620, the private signal part sₖ from the signal obtained by the interference cancellation 618.

LIST OF REFERENCE NUMERALS
(PART OF THE DESCRIPTION)

| | |
|---|---|
| 100 | method of determining process |
| 102 | invoke method? |
| 110 | receive selection input |
| 120 | select targeted properties |
| 130 | select error-processing |
| 140 | select design technique |
| 150 | implement and configure process |
| 200 | method of generating parameters |
| 202 | receive Ĥₖ and error statistics |
| 210 | initialise V_{c}, Vₖ, U_{c, k}, Uₖ |
| | and/or H and/or determining |
| | an initial worst-case of |
| | Ĥₖ ™ H, |
| 212 | approximate Rₜₒₜₐₗ |
| 214 | convexise |
| 220 | error-processing |
| 230 | iterative determination and |
| | optimisation |
| 232 | optimise V_{c}, Vₖ |
| 234 | solve convexised problem |
| 236 | update auxiliary variables |
| 238 | check convergence |
| 240 | optimise U_{c, k}, Uₖ |
| 242 | solve convexised problem |
| 244 | update auxiliary variables |
| 246 | check convergence |
| 254 | optimise V_{c}, Vₖ, U_{c, k} and Uₖ |
| 256 | estimate worst-case CSI |
| | error Ĥₖ |
| 258 | update worst-case CSI |
| | errors |
| 262 | decompose |
| 264 | update Bₖ |
| 266 | update C |
| 268 | update A |
| 270 | resource allocation |
| 272 | compute V_{c}, Vₖ, U_{c, k} and Uₖ |
| 280 | first loop termination |
| | criterion met? |
| 290 | second loop termination |
| | criterion met? |
| 292 | output V_{c}, Vₖ, U_{c, k}, Uₖ |
| 276 | estimate worst-case CSI |
| | error |
| 278 | update worst-case CSI error |
| 300 | base station |
| 302 | precoder |
| 304 | BF design/beamformer |
| 304a | CSI error determination |
| 304b | worst-case error |
| | determination |
| 304c | objective function selection |
| 304d | applied design technique |
| 306 | antenna |
| 308 | channel estimator |
| 350 | microprocessor |
| 352 | volatile memory |
| 354 | non-volatile memory |
| 356 | wireless interface circuitry |
| 358 | |
| 399 | feedback link |
| 400 | UE |
| 402 | antenna |
| 404a, b | combiner |
| 406 | detector |
| 408 | signal decoder (common) |
| 410 | IC |
| 412 | signal decoder (private) |
| 500 | method of operating first |
| | wireless device |
| 504a | execute methods 100 & 200 |
| 504b | receive precoding and |
| | combining parameters V_{c}, |
| | Vₖ, U_{c, k}, Uₖ |
| 506 | provide precoding and |
| | combining parameters V_{c}, |
| | Vₖ, U_{c, k}, Uₖ to precoder |
| 508 | split messages into private |
| | and common parts |
| 510 | precode private and |
| | common parts |
| 512 | transmit |
| 600 | method of operating second |
| | wireless device |
| 602 | receive precoding |
| | parameters |
| 604 | receive precoded signal |
| 606 | combine common/private |
| | signal parts |
| 608 | estimate transmitted signal |
| 610 | decoding common part |
| 612 | performing IC |
| 614 | decoding private part |
| 616 | output decoded signals |

1. A method of determining a process for generating precoding and combining parameters for wireless interfaces of a first and a second communication device, respectively, the first wireless communication device being configured for wireless communication with a plurality of second communication devices in a MU-MIMO RSMA communication system, the method comprising, for all communication channels with all of the plurality of second communication devices:
receiving a selection input for selecting a targeted property of the communication connections, a process for processing respective errors associated with estimated channel coefficient matrices of all communication channels, and a design technique, respectively,
selecting one from a plurality of sets of target properties for the communication connections in accordance with the selection input,
selecting one from a plurality of processes for processing the respective errors associated with the estimated channel coefficient matrices in accordance with the selection input,
selecting one of a plurality of design techniques for determining the precoding and/or combining parameters in accordance with the selection input, and
implementing and configuring a process for generating the precoding and/or combining parameters in accordance with the selected targeted properties of the communication connections, the selected error-processing, and the selected design technique, the process for generating being configured to use at least the estimated channel coefficient matrices and the output from the error-processing as inputs.

2. The method of claim 1, further including invoking the method at least in one of the instances including, but not limited to predetermined intervals, when a new second wireless communication device joins the plurality of second wireless communication devices connected with the first communication device, when one or more of the second wireless communication device leaves the plurality of second wireless communication devices connected with the first communication device, when the channel coefficients for at least one from the plurality of second wireless communication devices connected with the first communication device changes, and/or when a data message content and/or type to be transmitted to one or more from the plurality of second wireless communication devices connected with the first communication device changes.

3. The method of claim 1, wherein
the selectable targeted properties of the communication connections include total sum rate maximisation, minimum rate maximisation, or power minimisation with rate guarantee,
the selectable processes for error-processing include averaging the CSI error or estimating a worst-case CSI error, and
the selectable design techniques include iterative convex optimisation or tensor decomposition.

4. The method of claim 1, wherein implementing the process includes providing computer program instructions and/or data which represent a set of target properties of the communication connection, a process for processing the errors of the estimated channel coefficient matrices, and a computer-implemented algorithm for determining the precoding and/or combining parameters.

5. A method of generating precoding and combining parameters for wireless interfaces of a first and a second communication device, respectively, the first wireless communication device being configured for wireless communication with a plurality of second communication devices in a MU-MIMO RSMA communication system, the method being implemented and configured in accordance with the method of claim 1 and comprising:
receiving, as an input to the implemented and configured process, the estimated channel coefficient matrices and data on the error statistics thereof, for all communication channels between the first communication device and the second communication devices,
processing the error of the respective estimated channel coefficient matrices in accordance with the implemented process,
determining and/or optimising precoding and combining parameters in accordance with the implemented process and the selected set of target properties for the communication channels, using the previously received estimated channel coefficient matrix and data on the error statistics thereof as inputs, and
outputting the determined and/or optimised precoding and combining parameters.

6. The method of claim 5, wherein determining and/or optimising precoding and combining parameters includes
performing an iterative convex optimisation of the precoding and combining parameters,
performing a tensor decomposition on the estimated channel coefficient matrix into factors and a resource allocation on the results thereof prior to determining the precoding and combining parameters, and
repeating respective iteration or decomposition steps until a termination criterion is met.

7. The method of claim 6 wherein, when a tensor decomposition is performed, at least one of the decomposed factors is a set of diagonal matrices, in which at least one spatial position along the diagonal for the common signal is identical in all matrices, and in which the spatial positions along the diagonal for the multiple second wireless devices each have an aggregated overlap below a predetermined value or are mutually exclusive.

8. The method of claim 5, wherein error-processing includes averaging the error of the estimated channel coefficient matrix, or estimating a worst-case error for the estimated channel coefficient matrix.

9. The method of claim 8, wherein, when a worst-case error for the precoding and combining parameters is determined, the worst-case error determined for each iteration is fed back to the iterative convex optimisation or the tensor decomposition, respectively, as an input signal for the next iteration.

10. The method of claim 5, wherein the termination criterion comprises the condition that a change of values in the precoding and combining parameters between a current iteration and a foregoing iteration is smaller than a predefined threshold value, or that an improvement of a worst-case error estimated using the precoding parameter and the combiner parameters determined in the current iteration over a worst-case error determined in the preceding iteration or iterations is smaller than a predetermined threshold.

11. A method of operating a first wireless communication device wirelessly connected to a plurality of second wireless communication devices in a MU-MIMO RSMA communication system, comprising:
executing the method according to claim 1,
providing at least the precoding and combining parameters to a precoder of the first communication device and at least to each of the plurality of second wireless devices, to which messages are to be transmitted,
splitting messages to be transmitted to one or more from the plurality of second wireless communication devices into respective common parts and private parts and provide the split messages to the precoder,
precoding each of the private parts and the common parts, for obtaining transmission signals for each of a plurality of antennas of the first wireless communication device, and
transmitting the precoded transmission signals.

12. The method of claim 11, further comprising
receiving, as an input to the executing step, estimated channel coefficient matrices and data on the error statistics thereof, for all communication channels between the first communication device and the second communication devices.

13. The method of claim 12, wherein receiving comprises determining the estimated channel coefficient matrices and data on the error statistics thereof at the first wireless communication device, or receiving said information from the respective second wireless communication devices.

14. A method of operating a second wireless communication device wirelessly connected to a first wireless communication device in a MU-MIMO RSMA communication system, the method comprising:
receiving at least precoding and combining parameters from the first communication device,
receiving a signal from the first communication device, the signal comprising a common signal part and a private signal part and being precoded in accordance with the same precoding and combining parameters previously received from the first communication device,
combining the respective common and private signal parts received at the plurality of antennas using the previously received precoding and combining parameters that were used for precoding, for obtaining combined common signal parts and combined private signal parts,
providing the combined common signal parts and combined private signal parts to a detector, for estimating the transmitted common and private signal parts, respectively, and
providing the estimated signals at an output.

15. The method of claim 14, further comprising, prior to receiving the precoding and combining parameters from the first communication device:
estimating at least a channel coefficient matrix for the communication channel between the second wireless communication device and the first wireless communication device, and
transmitting the estimated channel coefficient matrix the first wireless communication device.

16. The method of claim 14, wherein estimating the transmitted common and private signals, respectively, comprises:
detecting the common signal part from the received signal, and
obtaining the private signal part using the knowledge of the detected common signal part.

17. The method of claim 14, further comprising, in the detector:
decoding the common signal part in a first decoder,
performing an interference cancellation using the decoded common signal part and the combined common signal parts and combined private signal parts obtained from the combining step as inputs,
decoding the private signal part from the signal obtained by the interference cancellation.

18. A wireless communication device comprising one or more microprocessors, volatile and non-volatile memory, a wireless interface circuitry configured for transmitting and/or receiving electromagnetic signals via multiple antennas, wherein the non-volatile memory stores computer program instructions which, when executed by the microprocessor, configure the wireless device to execute the method of claim 1.

19. A computer program product comprising computer program instructions which,
when executed by a microprocessor of a wireless communication device configured as a transmitter, cause the microprocessor to execute methods and to accordingly control hardware components of the transmitter of an RSMA MU-MIMO communication system in accordance with claim 1.

20. A non-transitory readable medium retrievably transmitting or storing the computer program product of claim 19.
